(19) United States
(12) Patent Application Publication
(10) Pub. No.: US 2026/0353457 A1
(43) Pub. Date: Nov. 5, 2026

(54) COMMUNICATION APPARATUS, CONTROL METHOD, AND NON-TRANSITORY COMPUTER READABLE STORAGE MEDIUM

(71) Applicant: CANON KABUSHIKI KAISHA, Tokyo (JP)

(72) Inventor: MASATOMO OUCHI, Tokyo (JP)

(21) Appl. No.: 19/712,332

(22) Filed: Jun. 18, 2026

Related U.S. Application Data
(63) Continuation of application No. PCT/JP2024/044653, filed on Dec. 17, 2024.

(30) Foreign Application Priority Data
Dec. 20, 2023 (JP) 2023-215051

(51) Int. Cl. H04W 74/0816

(52) U.S. Cl. CPC H04W 74/0816

(57) ABSTRACT

A communication apparatus compatible with an IEEE 802.11 series standard performs operations comprising: communicating with a first other communication apparatus in a TXOP period for transmitting data frames to the first other communication apparatus; receiving information for determining whether the first other communication apparatus allows a second other communication apparatus to transmit data frames in the TXOP period; and in a case of a determination that the first other communication apparatus allows the second other communication apparatus to transmit the data frames in the TXOP period, setting a waiting time before the communication apparatus transmits data frames in the TXOP period to be longer than the waiting time for a case of a determination that the first other communication apparatus does not allow the second other communication apparatus to transmit the data frames in the TXOP period.

### CROSS-REFERENCE TO RELATED APPLICATIONS

This application is a Continuation of International Patent Application No. PCT/JP2024/044653, filed Dec. 17, 2024, which claims the benefit of Japanese Patent Application No. 2023-215051, filed Dec. 20, 2023, both of which are hereby incorporated by reference herein in their entirety.

### BACKGROUND

### Field of the Technology

The present disclosure relates to a communication apparatus compatible with an IEEE 802.11 series standard, a control method, and a non-transitory computer readable storage medium.

### Description of the Related Art

The standards of the IEEE 802.11 series are known as communication standards related to a wireless local area network (a wireless LAN, hereinafter WLAN). According to the IEEE 802.11be standard, which is the latest standard, low-latency communication is realized, in addition to a high peak throughput, with use of a Multi-Link technique (US-2021-0211375).

At present, the IEEE has launched the IEEE 802.11bn Task Group (TG) to formulate a successor standard of 802.11be with an aim to further improve reliability. Here, one of the targets of consideration by the IEEE 802.11bn TG is low-latency communication (LL communication). In LL communication, there are cases where, even in a period in which communication is executed between a first communication apparatus (a TXOP holder) that has attained a transmission opportunity (TXOP) and a second communication apparatus (a TXOP responder), a third communication apparatus needs to interrupt and perform transmission. Such interruptive communication by the third communication apparatus is called a Preemption operation. Even in a case where the latency requirements for the LL communication cannot be satisfied if transmission is performed after the third communication apparatus waits for an elapse of a TXOP period, a latency request for the LL communication of the third communication apparatus can be satisfied by transmission pertaining to the Preemption operation (Preemption transmission). Meanwhile, as the Preemption transmission causes latency in the communication between the first communication apparatus that has attained the transmission opportunity and the second communication apparatus, there has been a problem that the Preemption transmission should not be permitted in some cases.

The present disclosure has been made in view of the aforementioned problem, and aims to provide a technique to improve convenience of the Preemption operation.

### SUMMARY

To solve the aforementioned problem, a communication apparatus of the present disclosure is a communication apparatus compatible with an IEEE 802.11 series standard, the communication apparatus comprising: at least one memory that stores a set of instructions; and at least one processor that executes the instructions, the instructions, when executed, causing the communication apparatus to perform operations comprising: communicating with a first other communication apparatus in a transmission opportunity (TXOP) period that is obtained by the communication apparatus and is for transmitting one or more data frames to the first other communication apparatus; receiving, from the first other communication apparatus, information for determining whether the first other communication apparatus allows a second other communication apparatus different from the first other communication apparatus to transmit one or more data frames to the communication apparatus in the TXOP period; and in a case of a determination, based on the received information, that the first other communication apparatus allows the second other communication apparatus to transmit the one or more data frames in the TXOP period, setting a waiting time before the communication apparatus transmits at least one data frame addressed to the first other communication apparatus in the TXOP period to be longer than the waiting time for a case of a determination that the first other communication apparatus does not allow the second other communication apparatus to transmit the one or more data frames in the TXOP period.

According to the present disclosure, a technique to improve convenience of a Preemption operation can be provided.

Features of the present disclosure will become apparent from the following description of embodiments with reference to the attached drawings.

### BRIEF DESCRIPTION OF THE DRAWINGS

The attached drawings are included in and constitute a part of the specification, illustrate embodiments of the present disclosure, and are used together with the description thereof to explain the principle of the present disclosure.

FIG. 1 is a configuration diagram of a wireless communication system according to the present embodiment;

FIG. 2 is a hardware configuration diagram of communication apparatuses according to the present embodiment;

FIG. 3 is a software configuration diagram of communication apparatuses according to the present embodiment;

FIG. 4A is a diagram showing a structure of a MAC frame;

FIG. 4B is a diagram showing a structure of a Frame Control field;

FIG. 5A is a diagram showing a structure of an Action frame of a Preemption request/response;

FIG. 5B is a diagram showing a structure of an Action field;

FIG. 5C is a diagram showing a list of category values;

FIG. 5D is a diagram showing a frame structure in which a Category for “UHR” has been set;

FIG. 5E is a diagram showing a structure of an Action field;

FIG. 5F is a diagram showing a frame structure of a Preemption request;

FIG. 5G is a diagram showing a frame structure of a Preemption response;

FIG. 5H is a diagram showing a structure of Common Info included in a Multi-Link Element;

FIG. 5I is a diagram showing a structure of a profile subelement for each STA;

FIG. 5J is a diagram showing a structure of STA Control;

FIG. 5K is a diagram showing a structure of an EDCA parameter set element;

FIG. 5L is a diagram showing a structure of Parameter Record;

FIG. 5M is a diagram showing a structure of an ACI/AIFSN;

FIG. 5N is a diagram showing correspondence between ACIs and access categories;

FIG. 6A is a diagram showing correspondence between Types and Subtypes of a MAC frame;

FIG. 6B is a diagram showing correspondence among Types, Subtypes, and Control Frame Extensions;

FIG. 6C is a diagram showing a structure of pRTS;

FIG. 6D is a diagram showing a structure of pCTS;

FIG. 7A is a diagram showing a structure of a MAC frame of BlockACK (BA);

FIG. 7B is a diagram showing a structure of BA Control;

FIG. 8 is a flowchart showing processing executed by an AP;

FIG. 9A is a flowchart showing downlink processing executed by the AP;

FIG. 9B is a flowchart showing downlink processing executed by the AP;

FIG. 10 is a processing flow executed by a TXOP responder (an STA);

FIG. 11 is a flowchart showing processing executed by an STA making a Preemption request;

FIG. 12 is a flowchart showing processing at the time of pRTS reception, which is executed by an STA making a Preemption request;

FIG. 13 is a flowchart showing Preemption transmission processing executed by an STA making a Preemption request;

FIG. 14A is a sequence diagram showing an example of processing according to embodiment examples 1 to 4;

FIG. 14B is a sequence diagram showing an example of processing according to first to fourth embodiment examples; and

FIG. 15 is a sequence diagram showing an example of processing according to a fifth embodiment example.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

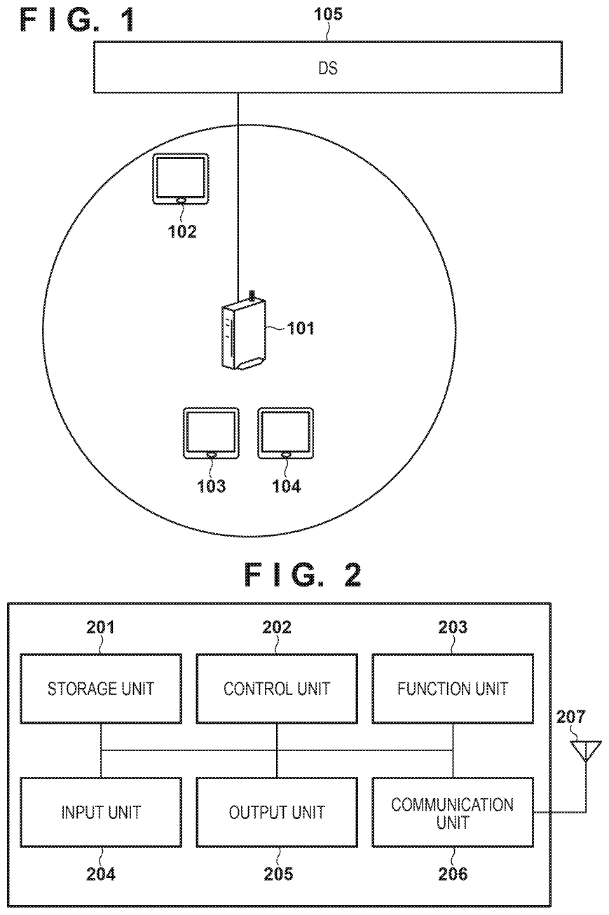

A configuration of a system according to the present embodiment will be described using FIG. 1. A wireless communication system 1 includes an access point (AP) 101 and a distribution system (DS) 105.

The AP 101 is a wireless communication apparatus that communicates with terminals (STAs) that can be located inside an area indicated by a circle in FIG. 1. In the example of FIG. 1, it is assumed that three STAs 102 to 104 exist inside a range in which connection to the AP 101 is possible (a service area); however, the number of STAs is not limited. The AP 101 manages a basic service set (BSS), which is a network composed of the AP 101 and the STAs 102 to 104.

The STAs 102 to 104 are wireless communication apparatuses that connect to the AP 101 and perform communication as clients. The STAs may also be referred to as non-AP STAs. The present embodiment will be described under the assumption that the AP 101 and the STAs 102 to 104 perform communication conforming to the standards of the IEEE 802.11 series.

The DS 105 is a network apparatus that provides a distribution system access function (DSAF) to the AP 101, and is connectable to not only the BSS composed of the AP 101 and the STAs 102 to 104, but also other BSSs and external networks. This access function (connection unit) is provided via wired communication such as Ethernet (registered trademark) and telephone lines, or wireless communication such as Long-Term Evolution (LTE) and Worldwide Interoperability for Microwave Access (WiMAX). Furthermore, the access function may be provided via wireless local area network (WLAN) communication conforming to the standards of the IEEE 802.11 series. In this case, a wireless channel used for WLAN communication between the AP 101 and the DS 105 may be the same as, or different from, wireless channels used for communication between the AP 101 and the STAs 102 to 104.

FIG. 2 shows a hardware configuration diagram of wireless communication apparatuses including the AP 101 and the STAs 102 to 104 according to the present embodiment. As an example of a hardware configuration, the wireless communication apparatuses include a storage unit 201, a control unit 202, a function unit 203, an input unit 204, an output unit 205, a communication unit 206, and an antenna 207.

The storage unit 201 is composed of a memory, such as a read-only memory (ROM) and a random-access memory (RAM), and stores programs for performing various types of operations that will be described later, and various types of information, such as communication parameters for wireless communication that will be described later. Note that other than the ROM, the RAM, and the like, such storage mediums as a flexible disk, a hard disk, an optical disc, a magneto-optical disc, a CD-ROM, a CD-R, a magnetic tape, a nonvolatile memory card, and a DVD may be used as the storage unit 201. Furthermore, the storage unit 201 may include a plurality of memories.

The control unit 202 includes one or more processors, and controls the operations of the entire wireless communication apparatus by executing programs stored in the storage unit 201. The processors include at least one or more of a central processing unit (CPU), a microprocessing unit (MPU), an application-specific integrated circuit (ASIC), a digital signal processor (DSP), and a field-programmable gate array (FPGA). Note that the control unit 202 may control the wireless communication apparatus through coordination with programs and an operating system (OS) stored in the storage unit 201. Also, the control unit 202 may include a plurality of processors, such as multiple cores, and the wireless communication apparatus may be controlled through coordination among the processors. Furthermore, the control unit 202 executes predetermined processing to realize functions of the wireless communication apparatus by controlling the function unit 203. For example, the wireless communication apparatus can execute processing that varies depending on a role of the wireless communication apparatus; the wireless communication apparatus can execute an AP function in a case where it is the AP 101, and the wireless communication apparatus can execute an STA function in a case where it is one of the STAs 102 to 104, for example. Furthermore, the control unit 202 can execute processing for realizing different functions, such as an image capturing function, a print function, and a projection function, in accordance with hardware included in the function unit 203.

The function unit 203 is hardware for the execution of predetermined processing by the wireless communication apparatus. In an example, the function unit 203 includes at least one of an image capturing unit, a printer unit, a projector unit, and a scanner unit. Under control of the control unit 202, the function unit 203 can realize different functions, such as the image capturing function, the print function, and the projection function.

The input unit 204 includes input interfaces that accept various types of operations from a user, such as buttons, a microphone, and a pointing device. The output unit 205 includes output interfaces that perform various types of outputs for the user, such as a display and a speaker. The outputs performed by the output unit 205 mentioned here include at least one of display on a screen, outputting of sounds via the speaker, outputting of vibrations, and the like. Note that both of the input unit 204 and the output unit 205 may be realized by one module, like a touch panel. For example, the input unit 204 and the output unit 205 may be realized by a touch panel.

The communication unit 206 controls wireless communication compatible with the standards of the IEEE 802.11 series, controls wireless communication conforming to Wi-Fi (registered trademark), and controls Internet Protocol (IP) communication. Furthermore, the communication unit 206 transmits and receives wireless signals for wireless communication by controlling the antenna 207. Specifically, the communication unit 206 is configured to be capable of executing communication of wireless frames conforming to the IEEE 802.11bn standard, which is a successor standard of the IEEE 802.11be standard aiming at a maximum transmission speed of 46.08 Gbps. Note that IEEE is an abbreviation for Institute of Electrical and Electronics Engineers. The main features of this IEEE 802.11bn, which is a successor standard of IEEE 802.11be, are highly reliable communication, low-latency communication, and improvements in throughput at the time of congestion. Also, one of the aims of 802.11bn is to suppress power consumption by APs. Wireless frames that are communicated under such a successor standard are also referred to as Ultra High Reliability (UHR) PPDUs. PPDU is an abbreviation for Physical Layer Protocol Data Unit. That is to say, the AP 101 and the STAs 102 to 104, which include the communication unit 206, realize communication by exchanging UHR PPDUs with one another. Note that the name UHR has been provided for convenience in light of the aims that should be accomplished by the successor standard and the key features of this standard, and can become another name in a state where the development of the standard is completed. Similarly, the name IEEE 802.11bn can also become another name in a state where the development of the standard is completed. Meanwhile, it should be noted that the present specification and the attached claims are essentially applicable to all successor standards of the 802.11be standard. Also, although it is assumed that the AP 101 and the STAs 102 to 104, which include the communication unit 206, support communication (transmission and reception) of UHR PPDUs, they can be configured to also support communication of PPDUs of the legacy standards, which are standards preceding the UHR standard, in addition thereto. Specifically, they can also be configured to support transmission and reception of PPDUs of the IEEE 802.11a/b/g/n/ac/ax/be standards and the like.

The antenna 207 includes one or more antennas. FIG. 2 shows only one antenna for simplicity. In general, the number of antennas included in the antenna 207 is the number that is in accord with the number of spatial streams.

Note that the communication unit 206 and the antenna 207 may include a plurality of communication units 206 and antennas 207 that are, in number, in accord with the number of streams corresponding to the corresponding frequency bands (2.4 GHz band, 5 GHz band, and 6 GHz band).

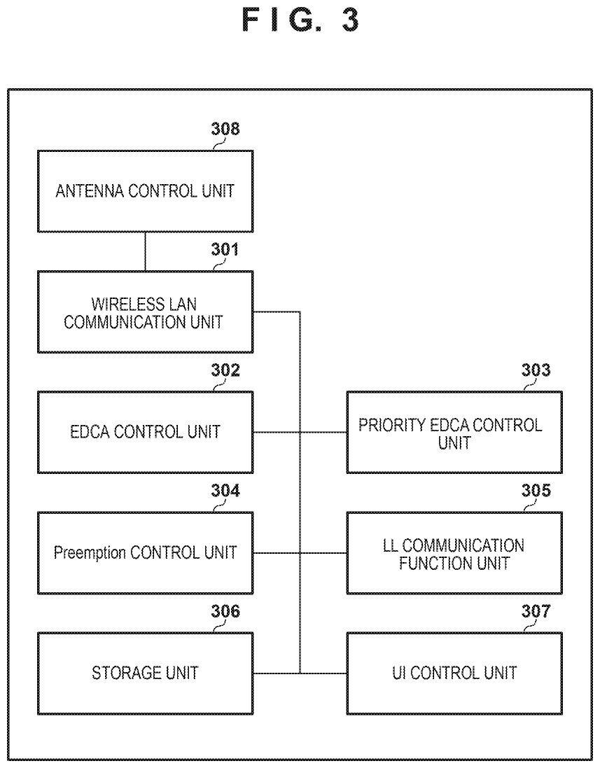

FIG. 3 shows an exemplary functional (software) configuration of the wireless communication apparatuses. The wireless communication apparatuses include a wireless LAN control unit 301, an Enhanced Distributed Channel Access (EDCA) control unit 302, and a priority EDCA control unit 303 as the software configuration. Also, the wireless communication apparatuses include a Preemption control unit 304, a low-latency (LL) communication function unit 305, a storage unit 306, a user interface (UI) control unit 307, and an antenna control unit 308 as the software configuration.

The wireless LAN control unit 301 is configured to include circuits for transmitting and receiving wireless communication signals to and from another wireless LAN apparatus (e.g., another AP or STA), and programs for controlling such circuits. The wireless LAN control unit 301 executes wireless LAN communication control, such as generation of frames, transmission of frames, and reception of wireless frames from another wireless LAN apparatus, in accordance with the standards of the IEEE 802.11 series.

After having recognized an idle (available) state of a wireless medium, the EDCA control unit 302 executes transmission processing after an elapse of a default frame interval and a backoff counter time. The EDCA is a priority control method prescribed by the IEEE 802.11 standards; it categorizes packets into four access categories (ACs), stores the packets into transmission queues, and transmits the packets in accordance with their respective priority degrees.

The priority EDCA control unit 303 performs transmission (Preemption transmission) related to an EDCA operation in a later-described Preemption announcement period when a Preemption operation can be performed.

The Preemption control unit 304 requests the AP 101 to permit Preemption transmission, and judges whether Preemption transmission has been permitted in the BSS. The Preemption transmission mentioned here denotes interruptive transmission by another STA (Preemption STA) during a period (TXOP period) assigned for communication between the AP 101 and one STA, which are a TXOP holder and a TXOP responder, respectively. The Preemption transmission by the Preemption STA during the TXOP period is realized by accessing a wireless medium using priority EDCA parameters, rather than normal EDCA parameters.

The LL communication control unit 305 controls communication that is sensitive to (limited by) latency and jitter (deviation), such as video communication and audio communication. The LL communication control unit 305 performs transmission related to an EDCA operation in a case where an application that requires communication sensitive to latency and jitter has been executed. In other words, in transmission other than Preemption transmission, the LL communication control unit 305 accesses a wireless medium using normal EDCA parameters by controlling the EDCA control unit 302. On the other hand, in a case where Preemption transmission has been permitted by the Preemption control unit 304, the LL communication control unit 305 accesses a wireless medium using priority EDCA parameters by controlling the priority EDCA control unit 303.

The storage unit 306 is configured to include a storage apparatus for saving programs executed by the wireless communication apparatus and various types of data, such as a read-only memory (ROM) and a random-access memory (RAM).

The UI control unit 307 is configured to include items of hardware related to a user interface (UI), like a touch panel or a button, for accepting an operation performed by a non-illustrated user with respect to the AP 101 and the STAs 102 to 104, and programs for controlling them. Note that the UI control unit 307 also has, for example, a function for presenting information to the user, such as display of images and the like, and outputting of sounds. The antenna control unit 308 controls an antenna function.

### MAC Frame Structure

A structure of a Medium Access Control (MAC) frame related to a Preemption operation will be described.

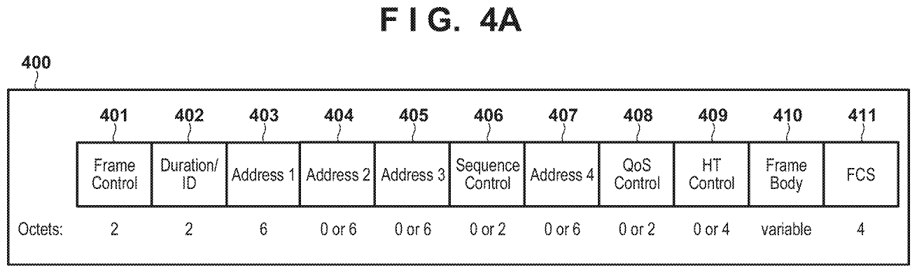

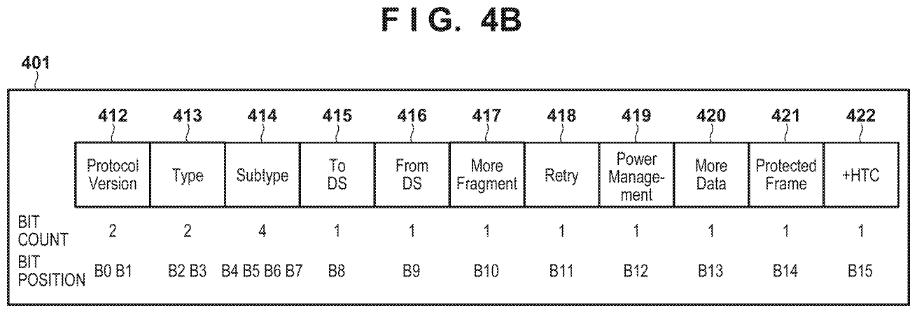

FIG. 4A shows a structure of a MAC frame used by the standards of the IEEE 802.11 series. A MAC frame 400 includes Frame Control 401, Duration 402, Address 1 403 to Address 3 405, Sequence Control 406, and Address 4 407. Also, the MAC frame 400 includes Quality of Service (QoS) Control 408, High Throughput (HT) Control 409, Frame Body 410, and Frame Check Sequence (FCS) 411.

Frame Control 401 is a 2-octet (16-bit) field including subfields 412 to 422, which will be described later with reference to FIG. 4B, and includes control information of the frame.

Duration 402 is a 2-octet (16-bit) field, and can provide a notification indicating time, such as a frame length and a length of a TXOP period, by setting the most significant bit (MSB: B15) at “1”. In this case, the 15 bits other than the MSB indicate the frame length and the length of the TXOP period using a value from 0 to 32767 microseconds.

Addresses 1 to 4, which are 403, 404, 405, and 407, are 6-octet (48-bit) fields that store information indicating an address of a wireless communication apparatus. A BSSID, a transmission source address, a destination address, and the like are set therein depending on the type (Type 413) and subtype (Subtype 414) of the MAC frame 400. Note that an address field to be used varies depending on the type, and Addresses 2 to 4, which are 404, 405, and 407, may be omitted.

Sequence Control 406 is a 0- or 2-octet field indicating a sequence number of data to be transmitted, or a fragment number thereof in a case where fragmentation has been performed.

QoS Control 408 is a 0- or 2-octet field for performing QoS control on data frames. A Buffer Status Report (BSR) of the standards preceding IEEE 802.11ax is stored in QoS Control 408.

HT Control (HTC) 409 is a 0- or 4-octet field including control information related to High Throughput HT or Very High Throughput (VHT).

Frame Body 410 is a variable-length field that stores various types of information elements (IEs) in a case where Type 413 of Frame Control 401 indicates a management frame, that is to say, a beacon or probe request/response.

FCS 411 is a 4-octet field that stores a value for inspecting whether a MAC header and a data portion are error-free. Frame Control 401 to QoS Control 408 represent the MAC header, and HT Control 409 and Frame Body 410 are referred to as a MAC Service Data Unit (MSDU).

Next, the details of Frame Control 401 will be described with reference to FIG. 4B. Frame Control 401 includes Protocol Version 412, Type 413, Subtype 414, To DS 415, From DS 416, and More Fragment 417. Furthermore, Frame Control 401 includes Retry 418, Power Management 419, More Data 420, Protected Frame 421, and +HTC 422.

Protocol Version 412 is a 2-bit field indicating a protocol version used in transmission of the MAC frame, and is set at “0” in the case of an IEEE 802.11 frame.

Type 413 is a 2-bit field indicating which one of the following types the MAC frame is: management, control, and data.

Subtype 414 is a 4-bit field indicating a subtype representing a finer classification of one of the types indicated by Type 413, namely management, control, and data.

To DS 415 is a 1-bit field indicating whether a destination of the MAC frame is the DS 105. From DS 416 is a 1-bit field indicating whether a transmission source of the MAC frame is the DS 105.

More Fragment 417 is a 1-bit field indicating whether the MAC frame has been divided. Retry 418 is a 1-bit field indicating whether the MAC frame is a retransmitted frame. Power Management 419 is a 1-bit field indicating whether a power save mode is in effect. More Data 420 is a 1-bit field indicating whether there is data addressed to an STA in a power save mode. Protected Frame 421 is a 1-bit field indicating whether the MSDU has been encrypted. +HTC 422 is a 1-bit field indicating whether the MAC frame 400 includes HT Control 409. A frame in which a bit “1” can be set in +HTC 422, that is to say, a frame that can include HT Control 409, is a QoS data, Management, or Request To Send (RTS) frame. Note that although there are more detailed conditions, a description thereof is omitted here.

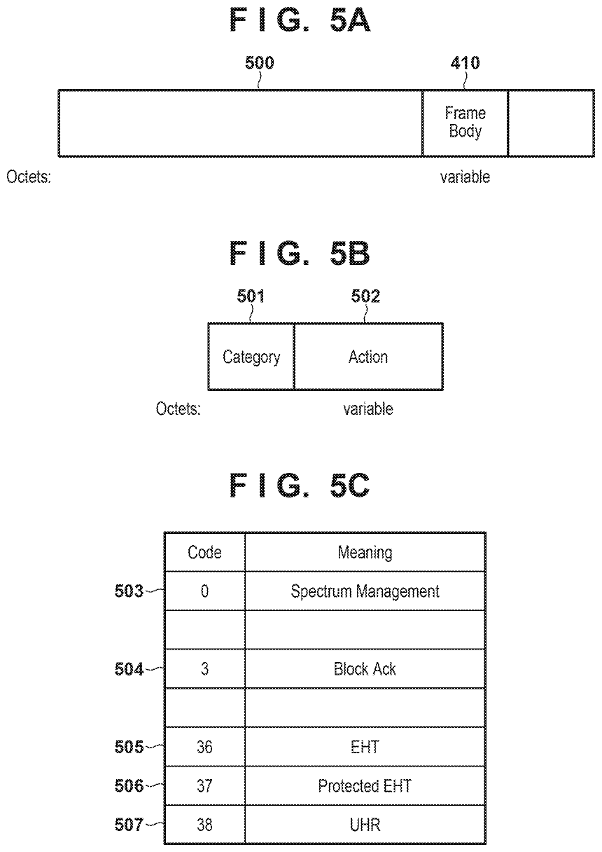

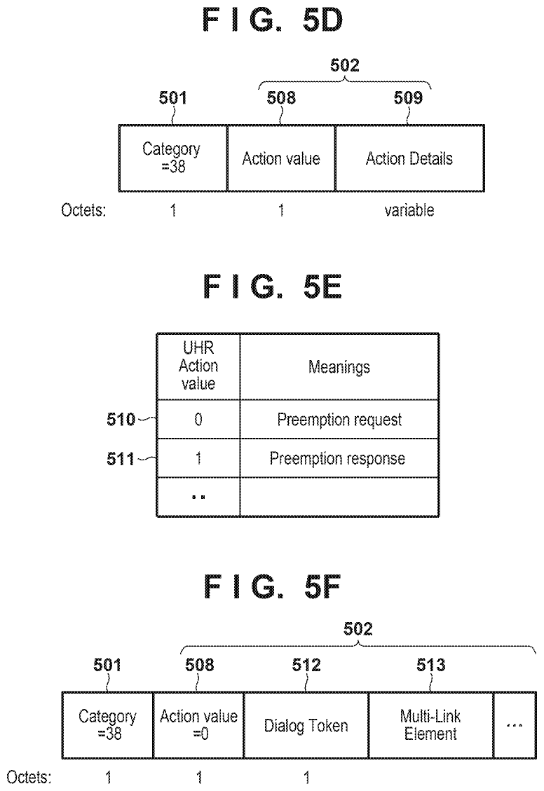

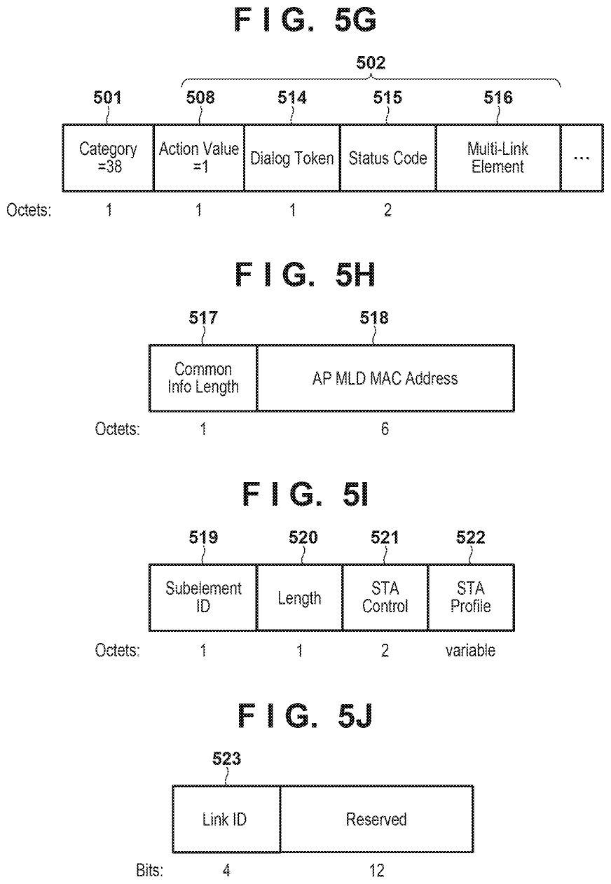

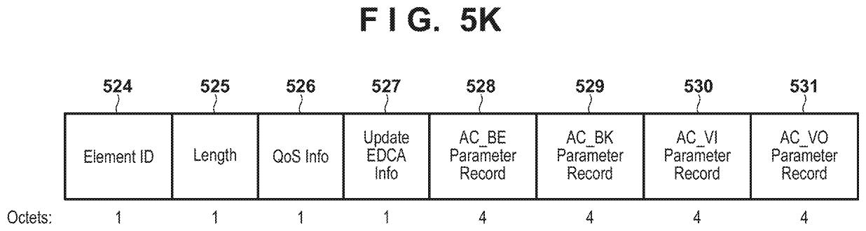

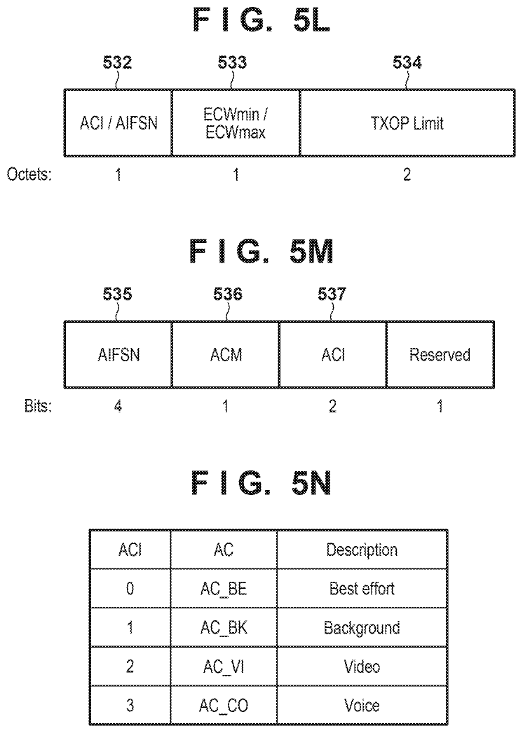

With reference to FIG. 5A to FIG. 5N, a description is now given of an exemplary configuration of an action frame that is transmitted and received when making a request for, or a response to, a Preemption operation according to the present embodiment.

An action frame 500 shown in FIG. 5A is similar to the MAC frame 400 that has been described with reference to FIG. 4A, and thus a description thereof is omitted. A MAC frame with Frame Control 401 in which Type 413 (bits B3 and B2) is set at “00” and Subtype 414 (bits B7, B6, B5, and B4) is set at “1101” is an action frame, which is one type of a management frame.

FIG. 5B shows an exemplary configuration of Frame Body 410 in the action frame 500. Frame Body 410 in the action frame 500 includes Category 501 and Action 502. Category 501 indicates that the MAC frame is an action frame. Category 501 is a 1-octet field, and Action 502 has a variable length.

FIG. 5C shows correspondence between codes set in Category 501 and the meanings thereof. In FIG. 5C, codes “0” to “37” are prescribed by the IEEE 802.11be Draft 4.0. For example, code “0” indicates “Spectrum Management”, code “3” indicates “Block ACK (BA)”, code “36” indicates “Extremely High Throughput (EHT)”, and code “37” indicates “Protected EHT”. The format of Action 502 is defined for each of these categories.

In the present embodiment, it is assumed that transmission and reception of a control signal related to a Preemption operation are enabled by newly defining code “38” as a value of Category 507 for “UHR”. However, Action Details of the control signal related to the Preemption operation may be defined under a value of existing Category 507, such as Action Details of code “37”. This means that a reserved value of the EHT category is also used for UHR. A specific description is now provided. Action 502 for EHT is composed of a 1-octet Action Value field that stores a type value indicating a type of an action, and a variable-length field that stores detailed information related to the action corresponding to the value of this Action Value field. In this case, the type value, which is a reserved value of EHT, is assigned to the control signal related to the Preemption operation. Then, a field configuration of the detailed information for the action corresponding to this type value is defined. Due to this mechanism, the reserved value of the EHT category can also be used for transmission of the control signal related to the Preemption operation for UHR. Note, it is sufficient that the specific action types and detailed information corresponding thereto be configured similarly to the later-described action types of the UHR category and detailed information thereof.

FIG. 5D shows a configuration of Frame Body set for code “38”, which indicates that the value of Category 501 is UHR. Regarding the action field for UHR, Action 502 includes 1-octet Action Value 508 that stores a type value indicating an action type, and variable-length Action Details 509 that store detailed information for the action corresponding to the type value. As Action Value 508 is Action Value for UHR, it is also referred to as UHR Action Value.

FIG. 5E is a diagram showing the definition of correspondence between the values set as Action Value 508 and the meanings thereof. In a case where “0” is set as Action Value, Action Value indicates a permission request (Preemption request) 510 for requesting a permission for the Preemption operation. In a case where “1” is set as Action Value, Action Value indicates a response (Preemption response) 511 to the request for permission for the Preemption operation.

FIG. 5F shows a configuration of an action frame for a case where “0” is set as Action Value 508, that is to say, for requesting a permission for the Preemption operation. The permission request is transmitted from an STA to the AP 101.

Regarding the action field for the Preemption request, Action 502 includes Action Value 508 in which code “0” is set, Dialog Token 512, and Multi-Link Element 513.

Dialog Token 512 is a 1-octet field. Dialog Token 512 is a field for distinguishing each request in a case where there are a plurality of requests.

Multi-Link Element 513 is a field that is also used in an action frame that will be described later with reference to FIG. 5G. The Preemption operation can be executed also in a Multi-Link configuration of IEEE 802.11be. Therefore, it is prescribed as a Multi-Link Element. Multi-Link Element 513 includes common information (Common Info) and a profile subelement for each STA as will be described later with reference to FIG. 5H.

FIG. 5G shows a configuration of an action frame for a case where “1” is set as Action Value, that is to say, for responding to a request for permission for the Preemption operation. The permission request is transmitted from the AP 101 to an STA.

Regarding the action field for responding to the permission request shown in FIG. 5G, Action 502 includes Action Value 508 in which code “1” is set. Also, Action 502 includes Dialog Token 514, Status Code 515, and Multi-Link Element 516.

Dialog Token 514 is a 1-octet field. Dialog Token 514 is a field for distinguishing each request in a case where there are a plurality of requests.

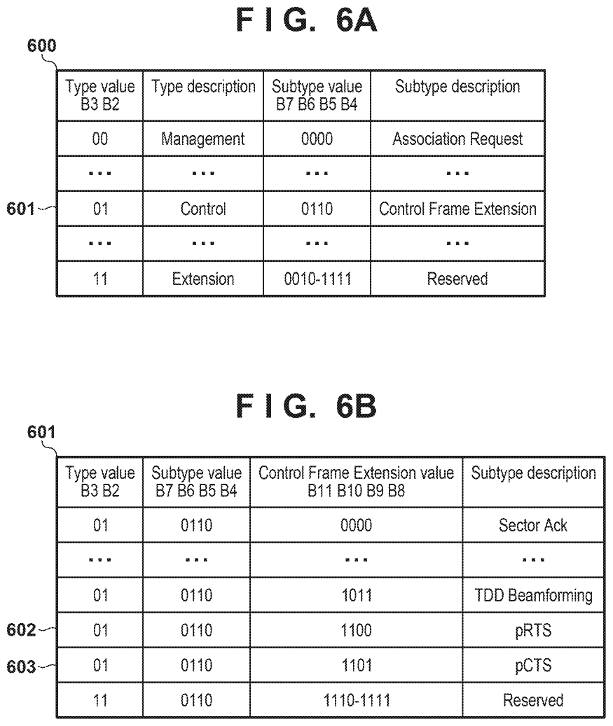

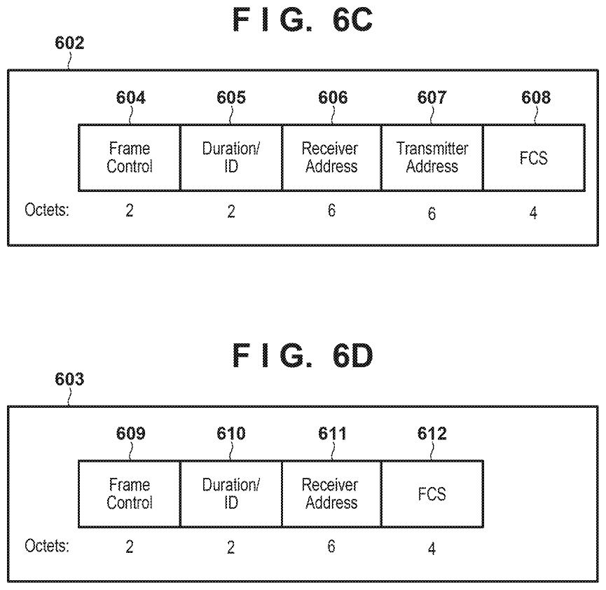

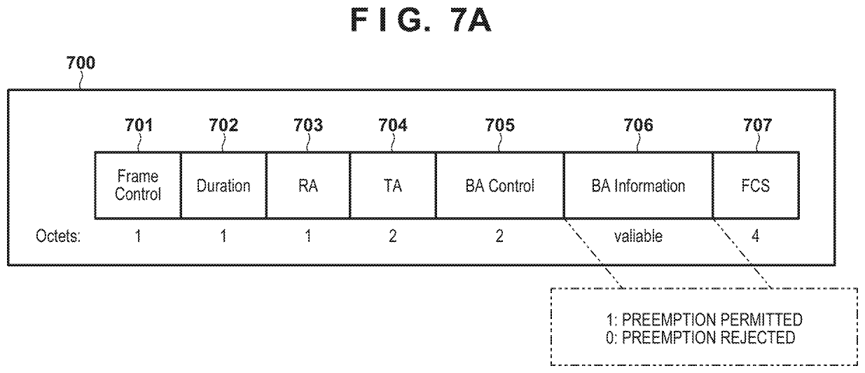

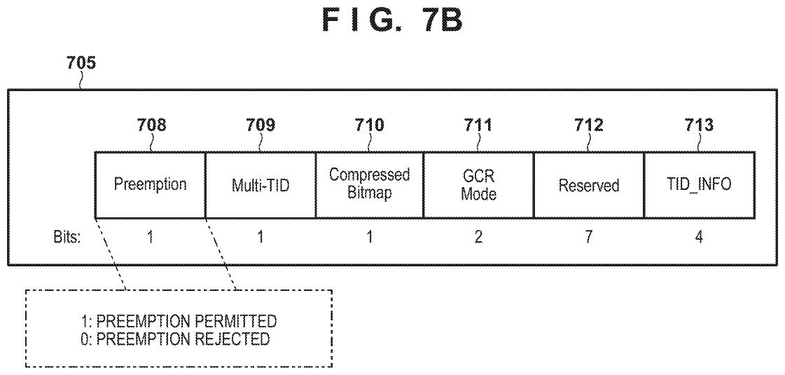

Status Code 515 is a 2-octet field, and is prescribed by IEEE 802.11. The AP 101 sets “0 (SUCCESS)” thereas in a case where it is to allow the request for permission for the Preemption operation. In a case where the request is not to be allowed, non-permission (rejection) is indicated using a value that has already been reserved in accordance with the conventional standards. For example, the AP 101 can decide to permit or reject the Preemption operation under a predetermined condition, such as a condition where the number of STAs that can perform the Preemption operation in the BSS has been decided. Note that in the present embodiment, the Preemption operation can be permitted or rejected also by an STA operating as a TXOP responder, as will be described later. A structure of a MAC frame that is transmitted by an STA to permit or reject the Preemption operation will be described later with reference to FIG. 6A, FIG. 6B, and FIG. 7B.

As Multi-Link Element 516 is similar to Multi-Link Element 513 of FIG. 5F, a description thereof is omitted.

FIG. 5H shows an exemplary configuration of common information (Common Info) included in Multi-Link Elements 513 and 516. The common information includes Common Info Length 517 and AP MLD MAC Address 518. Common Info Length 517 is a 1-octet field, and AP MLD MAC Address 518 is a 6-octet field.

FIG. 5I shows a configuration of a profile subelement for each STA included in Multi-Link Elements 513 and 516. The profile subelement for each STA includes Subelement ID 519, Length 520, STA Control 521, and STA Profile 522. Subelement ID 519 is a 1-octet field, Length 520 is a 2-octet field, and STA Control 521 is a 2-octet field. STA Profile 522 is a variable-length field. STA Profile 522 includes at least an EDCA parameter set element. As stated earlier, the EDCA parameter set included in STA Profile 522 of a MAC frame transmitted as a response to a Preemption permission request is priority EDCA parameters for performing Preemption transmission in a TXOP period.

FIG. 5J shows an exemplary configuration of STA Control 521. It is assumed that STA Control 521 includes 4-bit Link ID 523, and the remaining 12 bits have already been reserved. Link ID 523 is an identifier of a link requesting the Preemption operation.

FIG. 5K shows an exemplary configuration of the EDCA parameter set element included in STA Profile 522 of FIG. 5I. The EDCA parameter set element complies with the standard of IEEE 802.11-2020; thus, regarding the items that have the same meanings as and are used in the same manner as in the conventional standards, only field names are presented.

The EDCA parameter set element includes Element ID 524, Length 525, QoS Info 526, and Update EDCA Info 527, each of which is a 1-octet field. Also, the EDCA parameter set element includes Parameter Records 528 to 531 corresponding to four access categories (BE: Best Effort, BK: Background, VI: Video, and VO: Audio), each of which is a 4-octet field. Parameter Record 528 is AC_BE Parameter Record, and Parameter Record 529 is AC_BK Parameter Record. Parameter Record 530 is AC_VI Parameter Record, and Parameter Record 531 is AC_VO Parameter Record.

As shown in FIG. 5L, each of Parameter Records 528 to 531 includes ACI/Arbitration Inter Frame Space Number (AIFSN) 532, ECWmin/ECWmax 533, and TXOP Limit 534.

ACI/AIFSN 532 is a 1-octet field, and includes four subfields as will be described later with reference to FIG. 5M.

ECWmin/ECWmax 533 is a 1-octet field, is used in calculation of a contention window for collision avoidance at the time of an EDCA access, and is defined by the following expressions.

CWmin=2^{ECWmin}−1

CWmax=2^{ECWmax}−1

Here, CWmin indicates a lower limit value of the contention window, and CWmax indicates an upper limit value of the contention window. According to the conventional standards, the range of the foregoing CWmin and CWmax has a minimum value of 0 and a maximum value of 32767. At this time, priority control is realized by setting differences in a default value, or in a range indicated by values of beacon notifications, among the access categories.

In an example, both of CWmin and CWmax are 0. With this setting, the access right is attained after the backoff counter has been set at 0 (zero) and the time equivalent to an AIFSN after a Short IFS (SIFS) has elapsed, thereby enabling access control appropriate for LL communication.

TXOP Limit 534 is a field with a length of 2 octets, and is a limited time of a one-time access right; its unit is 32 microseconds. According to the conventional standards, AC_VI is prescribed to be 4.096 milliseconds, and AC_VO is prescribed to be 2.080 milliseconds. Also, TXOP Limit=0 has a special meaning, and indicates that only one MAC Service Data Unit (MSDU) or MAC Management Protocol Data Unit (MMPDU) can be transmitted.

FIG. 5M shows an exemplary structure of ACI/AIFSN 532. ACI/AIFSN 532 includes 4-bit AIFSN 535, 1-bit Admission Control Mandatory (ACM) 536, 2-bit Access Category Index (ACI) 537, and a 1-bit Reserved field.

AIFSN 535 indicates the number (time) of slots until backoff control is activated after an SIFS at the time of an EDCA access. Although a minimum value thereof is 2 under the conventional standards, 0 or 1 can be designated in the present embodiment. Furthermore, the time of slots is also referred to as aSlotTime, and the IEEE 802.11 standards define a value thereof in accordance with each physical layer. For example, according to OFDM used in accordance with 802.11n onward, the value is 9 microseconds in the 5 or 6 GHz band, and is 9 or 20 microseconds in the 2.4 GHz band.

As shown in FIG. 5N, ACI 537 is associated with four access categories. For example, in a case where ACI 537 is set at “0”, it indicates that the access category is “AC_BE”, that is to say, Best Effort communication is to be performed.

Note that STA Profile 522 of a Preempt response may include information indicating that a request is not to be permitted, rather than EDCA parameters per se. For example, a new ID indicating that a request is not to be permitted can be added to Element ID 524.

FIG. 6A is a table of combinations of Type 413 and Subtype 414 in the header of the MAC frame shown in FIG. 4B. The table includes a combination 601 of Type and Subtype indicating Control Frame Extension for a case where Type 413 is set at “01” and Subtype 414 is set at “0110”. In a case where Type 413 and Subtype 414 in the header of the MAC frame are set to be the combination 601, the following 4 bits are construed as a Control Frame Extension field.

FIG. 6B is a diagram showing the details of a Control Frame Extension value in the Control Frame Extension field. With Control Frame Extension 601 according to the present embodiment, Preempt Request To Send (pRTS) 602 and Preempt Clear To Send (pCTS) 603 are newly defined as the Control Frame Extension value. Here, pRTS and pCTS are indicated in a case where the Control Frame Extension value is 1100 and 1101, respectively. A frame in which the Control Frame Extension value is set at pRTS (a pRTS frame) is handled as an occupancy request frame that is transmitted to obtain a TXOP period. A frame in which the Control Frame Extension value is set at pCTS (a pCTS frame) is handled as an occupancy response frame that is a response to an occupancy request frame. Note FIG. 6B shows Bit numbers in descending order from left to right, in line with the customary notation of the IEEE 802.11 standards. That is to say, a MAC frame in which a Type field is set at “01”, a Subtype field is set at “0110”, and a Control Frame Extension field is set at “1100” is referred to as a pRTS frame. Similarly, a MAC frame in which a Type field is set at “01”, a Subtype field is set at “0110”, and a Control Frame Extension field is set at “1101” is referred to as a pCTS frame.

FIG. 6C shows a frame structure of a pRTS frame. The pRTS frame is an occupancy request frame that requests an STA in the BSS for obtainment of a transmission opportunity, and is also a control frame indicating a period in which the Preemption operation can be performed. Furthermore, a pRTS destination construes the pRTS frame as a permission request signal requesting a permission for the Preemption operation.

The pRTS frame includes Frame Control 604, Duration 605, Receiver Address (RA) 606, Transmitter Address (TA) 607, and FCS 608.

Frame Control 604 is similar to Frame Control 401 of the MAC frame structure of FIG. 4A. Duration 605 is a period in which the Preemption operation can be performed, and may also be referred to as a Preemption announcement period. RA 606 indicates a MAC address of a destination of the pRTS frame, and a MAC address of a TXOP responder is set thereas in the present embodiment. TA 607 indicates a MAC address of a transmission source of the pRTS frame, and a MAC address of a TXOP holder is set thereas in the present embodiment. FCS 608 is similar to FCS 411 of the MAC frame structure of FIG. 4A.

Here, in the present embodiment, there are cases where a pCTS frame rejects the Preemption operation after a notification of the Preemption announcement period has been provided by the pRTS frame. In this case, Duration 605 is construed as a TXOP period.

FIG. 6D shows a structure of a pCTS frame. As stated earlier, the pCTS frame is a control frame indicating that a TXOP responder permits the Preemption operation with respect to an STA in the BSS. The pCTS frame includes Frame Control 609, Duration 605, RA 611, and FCS 612.

Frame Control 609 is similar to Frame Control 401 of the MAC frame structure of FIG. 4A. Duration 610 stores a value indicating an end point of a period that matches an end point of a period indicated by Duration 605 of pRTS. RA 611 indicates a MAC address of a TXOP holder that has transmitted the pRTS frame, which is a destination of the pCTS frame. In the present embodiment, a MAC address of the TXOP holder is set thereas. FCS 612 is similar to FCS 411 of the MAC frame structure of FIG. 4A.

Note that in the present embodiment, it is assumed that the receiver of pRTS returns a conventional CTS frame in a case where the TXOP responder does not permit the Preemption operation. In this way, the TXOP responder can notify a terminal group, including the TXOP holder, of whether the Preemption operation is permitted by switching between transmission of the pCTS frame or transmission of the conventional CTS frame with respect to the pRTS frame.

However, the TXOP responder may provide a notification of whether the Preemption operation is permitted by including information indicating whether the Preemption operation is permitted in the CTS frame. For example, it is permissible to indicate that the Preemption operation is permitted in a case where RA 611 is a broadcast address, and indicate that the Preemption operation is rejected in a case where RA 611 is the address of the TXOP holder. That is to say, information that can determine whether the Preemption operation is permitted may be included in one of Frame Control 609, Duration 610, and RA 611 of the CTS frame.

Also, information indicating whether the Preemption operation is permitted may be included in the pCTS frame, which is the occupancy response. That is to say, similarly to a case where the notification is provided using the CTS frame, information that can determine whether the Preemption operation is permitted may be included in one of Frame Control 609, Duration 610, and RA 611 of the pCTS frame. Alternatively, unlike FIG. 6B, two types of pCTS frames may be defined as pCTS frames that act as occupancy responses. This can be realized by, for example, defining a value for permitting the Preemption operation and a value for rejecting the Preemption operation as the Control Frame Extension value.

Furthermore, the TXOP responder according to the present embodiment may include information indicating whether the Preemption operation is permitted in a Block ACK (BA) that provides a notification indicating that data frames have been received.

FIG. 7A shows a structure of a BA frame. It is assumed that, in the description of the BA frame, only names are presented regarding the items that have the same meanings as and are used in the same manner as in the conventional standards.

Frame Control 701 is similar to Frame Control 401 of the MAC frame structure of FIG. 4A. It is possible to indicate that the MAC frame is the BA frame by setting the value of Frame Control 401 as shown in FIG. 5C.

As Duration 702, RA 703, and TA 704 are similar to Duration 605 to TA 607 that have been described using FIG. 6C, a description thereof is omitted. The details of BA Control 705, which is a 2-octet field, will be described later with reference to FIG. 7B. BA Information 706, which is a variable-length field, may include a 1-bit field indicating whether the TXOP responder permits the Preemption operation, in addition to information related to a BA, in the present embodiment. FCS 707 is similar to FCS of the MAC frame structure of FIG. 4A.

FIG. 7B shows a structure of BA Control 705 of FIG. 7A. BA Control 705 includes Preemption 708, Multi-Traffic Identifier (TID) 709, Compressed Bitmap 710, GCR Mode 711, Reserved 712, and TID_INFO 713.

Preemption 708 is a field indicating whether the Preemption operation is permitted; 1 and 0 are set thereas in a case where the Preemption operation is permitted and rejected, respectively. Note that this field indicates Reserved under the conventional standards. As Multi-TID 709, Compressed Bitmap 710, GCR Mode 711, Reserved 712, and TID_INFO 713 are similar to those of the conventional standards of IEEE 802.11, a description thereof is omitted.

Alternatively, as shown in FIG. 7A, whether preemption is permitted may be indicated by the value of BA Information 706.

In this way, in the present embodiment, the TXOP responder can indicate permission and rejection of the Preemption operation not only by transmission of the pCTS frame, but also by transmission of the BA frame. Therefore, during a Preempt announcement period, an STA that has been permitted to perform the Preemption operation may judge whether the Preemption operation is permitted or rejected by monitoring a BA from another terminal without entering a power save mode state.

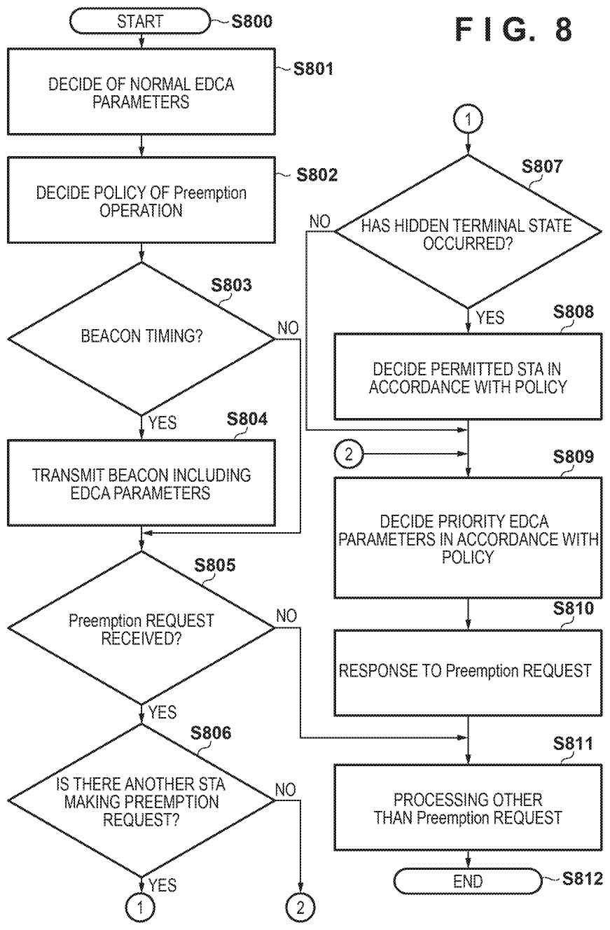

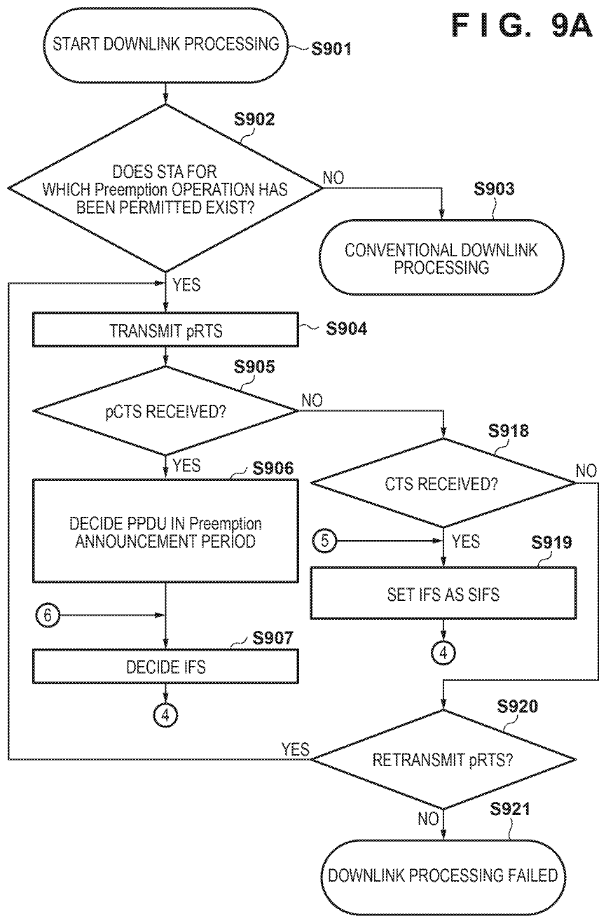

FIG. 8 is a flowchart showing an example of processing executed by the control unit 202 of the AP 101. A description will be provided under the assumption that the executor of operations is the AP 101, unless specifically stated otherwise.

In step S800, the control unit 202 starts processing. For example, processing is started at the time of control processing that does not involve data frames, and is executable at any timing except for during a Preemption operation period. For example, processing is started at the start of processing for generating a beacon, which is transmitted at a predetermined interval, or when a MAC frame has been received from an STA.

In step S801, the control unit 202 decides EDCA parameters in a normal state (normal EDCA parameters). The normal state means a state that is not during the Preemption operation period. Note that processing of step S801 may be omitted in a case where default values of EDCA parameters have been set in the wireless communication system, or in a case where default values are prescribed by the standards.

In step S802, the control unit 202 decides a policy of the Preemption operation. Here, a first parameter of the policy is the number of wireless communication apparatuses that can perform the Preemption operation. The range of this value is from 0 to the number of connectable apparatuses. A second parameter of the policy is a setting of an access condition for a case where the number of wireless communication apparatuses that can perform the Preemption operation is equal to or larger than two. Specifically, this is a setting of a condition for rejecting a request, cancelling the Preemption operation of a wireless communication apparatus that is lowest in the priority order, or the like when a request has been further received from an STA in a state where a limit value of the number of apparatuses connectable for the Preemption operation has been reached. Here, the priority order can be arbitrarily set in accordance with, for example, types of wireless communication apparatuses (XR/AR/VR/MR related to virtual reality, a game device, and so forth). The policy of the Preemption operation may be selected from among candidates for the policy that have been defined in advance by a manager of the AP 101, or may be decided in accordance with a communication environment, such as a packet loss rate and the number of packet collisions. Also, the policy of the Preemption operation may be decided in accordance with a state of the AP 101, such as a buffer state and a load state of the AP 101.

In step S803, the control unit 202 detects a transmission timing of a beacon signal. In step S804, the control unit 202 transmits a beacon signal including the normal EDCA parameters decided in step S801 by controlling the communication unit 206. Note that in a case where processing of step S801 has been omitted, the control unit 202 may transmit a beacon signal that does not include the normal EDCA parameters in step S803.

In step S805, the control unit 202 judges whether a frame transmitted from one of STAs is a Preemption operation request. In a case where it has been judged that a frame transmitted from an STA indicates a Preemption operation request (YES of step S805), the control unit 202 causes processing to proceed to step S806. In a case where it has been judged that a frame of the conventional standards, that is to say, a frame that is not a Preemption operation request has been received (NO of step S805), processing proceeds to step S810.

In step S806, whether another STA that has been permitted to perform the Preemption operation in step S805 exists is confirmed. In a case where another STA that has been permitted to perform the Preemption operation exists (YES of step S806), the control unit 202 causes processing to proceed to step S807; otherwise, it causes processing to proceed to step S809.

In step S807, the control unit 202 judges whether a hidden terminal state has occurred in the wireless communication system, and causes processing to proceed to step S809 if such a state has not occurred. In a case where the hidden terminal state has occurred (YES of step S807), the control unit 202 causes processing to proceed to step S808. The judgment about whether the hidden terminal state has occurred in step S807 is based on a report on the number of recognized terminals from each STA. A report on the number of recognized terminals includes information indicating that each STA has detected signals transmitted from other STAs, which is provided from each STA to the AP 101 at a certain time interval. In this way, the AP 101 can determine whether the STAs connected to the AP 101 are mutually detected by one another. The AP 101 stores the number of recognized terminals of each STA from the received reports on the number of recognized terminals. Based on the reports on the number of recognized terminals, the AP 101 can detect that one of the STAs has not detected another one of the STAs that is connected to the AP, that is to say, one of the STAs cannot detect signals transmitted from another one of the STAs in the wireless communication system. In such a case, the AP 101 judges that the hidden terminal state has occurred. On the other hand, in a case where all STAs have mutually detected STAs connected to the AP 101, it can be judged that the hidden terminal state has not occurred. Note, it is assumed that, in a report on the number of recognized terminals, an STA reports other recognized STAs as the number of recognized terminals; however, in an example, identifiers of the recognized STAs may be included in a report to the AP 101.

In step S808, the control unit 202 decides an STA for which the Preemption operation is to be permitted in accordance with the policy decided in step S802. As stated earlier, this policy can be decided arbitrarily for each wireless communication system in such a manner that, for example, “the Preemption operation is permitted preferentially for an STA whose apparatus type is a game device”. In another example, the policy may permit the Preemption operation in the order of transmission of a Preemption operation request. For example, if the setting is such that the Preemption operation is not permitted in a case where the hidden terminal state has occurred, it may be judged that the Preemption operation is not permitted for any STA. This can prevent the occurrence of collision resulting from the execution of Preemption transmission by an STA that has not been able to detect transmission from an STA operating as a TXOP Responder through carrier sensing. The present example will be described under the assumption that the Preemption operation is permitted for an STA that has transmitted a Preemption request.

In step S809, the control unit 202 decides priority EDCA parameters to be used when accessing a medium in accordance with the policy. Note that in a case where the Preemption operation is not permitted for the STA that has transmitted the Preemption request in step S808, processing of step S809 may be omitted. In an example, step S809 can include deciding of an Arbitrate Inter Frame Spacing Number (AIFSN). In the present embodiment, it is assumed that the priority EDCA parameters include an AIFSN with a value larger than 0.

In an example, in step S809, the control unit 202 may decide priority EDCA parameters based on another STA for which the Preemption operation has been permitted. For example, a priority degree may be judged based on a traffic type of the STA, and in a case where this priority degree has been judged to be lower than priority degrees of other STAs for which the Preemption operation has already been permitted, it is permissible to provide a notification of parameters that are inferior to priority EDCA parameters of which other STAs have been notified. Inferior parameters are, for example, parameters including a large AIFSN. In this way, by causing STAs for which the Preemption operation is permitted to access a medium using different EDCA parameters, collision of transmissions from a plurality of STAs can be prevented, and convenience of the Preemption operation can be improved.

In step S810, the control unit 202 makes a response to the Preemption permission request. In a case where the Preemption operation is permitted, the response to the Preemption permission request (a Preemption response) includes information indicating the permission and the priority EDCA parameters. Meanwhile, in a case where the Preemption operation is not permitted, the Preemption response includes only information indicating the non-permission, or normal EDCA parameters that are the same as EDCA parameters in the normal state. It is assumed here that permission/non-permission is indicated by Status Code 515 shown in FIG. 5G.

In step S811, if control processing other than the response to the Preemption request is necessary, the control unit 202 executes such processing. That is to say, processing of step S811 may be omitted. After processing of step S811, the control unit 202 ends processing shown in FIG. 8 (step S812).

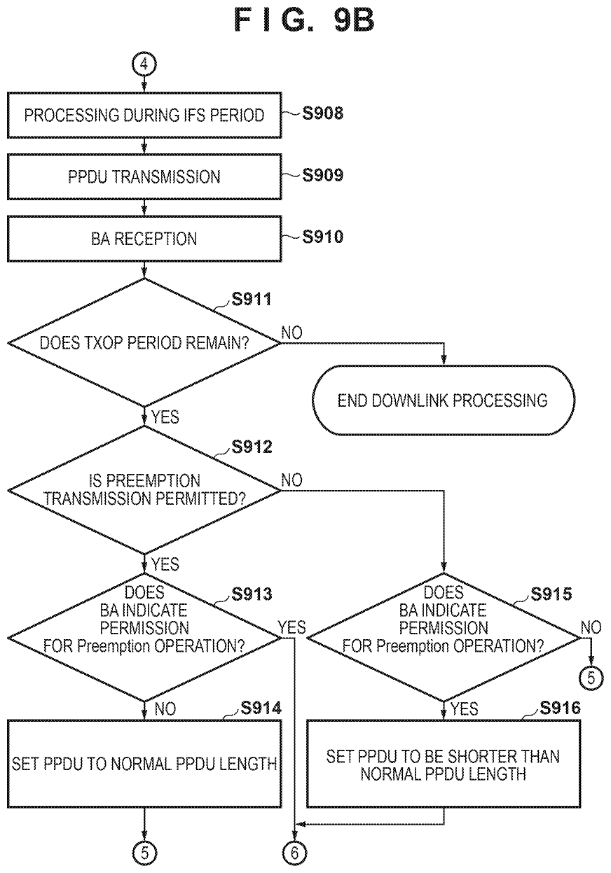

FIG. 9A and FIG. 9B are flowcharts showing an example of processing of the AP 101 that is executed in downlink communication from the AP 101 to an STA. A description will be provided under the assumption that processing of FIG. 9A and FIG. 9B is executed by the control unit 202 of the AP 101.

Step S901 is a start point of downlink processing, and processing of FIG. 9A and FIG. 9B is started in a case where data frames addressed to the connected STA have been recognized. Data thereof is generated by a communication apparatus in the DS 105, another STA in the BSS, or an application of the AP 101. The present example will be described under the assumption that the AP 101 has received downlink data addressed to the STA 102 from the DS 105.

In step S902, the control unit 202 confirms whether there is an STA for which the Preemption operation has been permitted. In a case where an STA with the permission does not exist (NO of step S902), the control unit 202 executes processing similar to conventional processing (step S903). That is to say, the control unit 202 performs an RTS/CTS procedure in a TXOP period as necessary, includes the data in Physical Layer Protocol Data Units (PPDUs), aggregates the plurality of PPDUs, and transmits them. As an STA for which the Preemption operation has been permitted does not exist, transmission through the Preemption operation is not executed in the TXOP period in step S903. The maximum length of the PPDUs transmitted from the AP 101 to the STA 102 in step S903 is referred to as a “normal PPDU length”.

In a case where an STA with the permission exists (YES of step S902), the control unit 202 causes processing to proceed to step S904, and transmits a pRTS frame to the STA 102 that is a destination of data frames, that is to say, a TXOP responder. Through reception of the pRTS frame, the STA 102 recognizes that it is requested to permit the Preemption operation. Therefore, the STA 102 judges whether to permit the Preemption operation in accordance with a policy, and transmits a response with which whether the Preemption operation is to be permitted can be determined.

Subsequently, the control unit 202 causes processing to proceed to step S905, and judges whether a pCTS frame has been received. In a case where the AP 101 has received a pCTS frame (YES of step S905), the control unit 202 causes processing to proceed to step S906. In a case where the AP 101 has not received a pCTS frame (NO of step S905), the control unit 202 causes processing to proceed to step S918. As stated earlier, pCTS is a response signal that is transmitted in a case where the TXOP responder permits the Preemption operation. Therefore, the AP 101 executes processing of step S906 onward as processing for a case where it has been judged that Preemption operation has been permitted by the TXOP responder.

In step S906, the control unit 202 decides the maximum length (a first length) of the PPDUs transmitted in a period in which the Preemption operation is permitted. The first length is decided so that it is shorter than the maximum length (a second length) of the PPDUs transmitted in a case where the Preemption operation is not permitted, so as to speed up a transmission opportunity of an STA other than the TXOP responder through the Preemption operation.

In the present embodiment, the first length and the second length are decided as prescribed values in the wireless communication system. In an example, the first length is set to be shorter than the second length at a rate that has been set in advance; for example, the first length is half of the second length. In another example, the first length may be decided based on the length of the remaining time of the TXOP period; for example, the first length is the time equal to or shorter than half of the remaining time of the TXOP period.

Note that in step S906, it is sufficient to change the PPDUs to speed up a transmission opportunity of an STA other than the TXOP responder through the Preemption operation, and any change can be made.

For example, it is permissible to only shorten the length of one of the PPDUs transmitted from the AP 101 to the STA 102 in the TXOP period. For example, it is permissible to shorten the maximum length of the PPDUs transmitted from the AP 101 to the STA 102 in the first half of the TXOP period, and set the normal PPDU length as the maximum length of the PPDUs transmitted in the last half of the TXOP period. In this case, although the maximum length of the PPDUs transmitted in the TXOP period does not seem to have been changed, the number of intervals between data frames increases as short PPDUs are transmitted in the first half. This can increase the opportunity of the occurrence of transmission through the Preemption operation.

In step S907, the control unit 202 decides an IFS in the period in which the Preemption operation is permitted. The AP 101 can decide the value of the IFS optionally in accordance with the policy. For example, in the case of a policy whereby “the first PPDU is always transmitted”, an SIFS is set. At this time, it is assumed that the AIFSN of the STA that has requested the Preemption operation is not 0. In this way, the SIFS ends in less time than the elapse of the backoff time of the STA that has requested the Preemption operation, and thus the AP 101 can acquire the opportunity to transmit PPDUs. On the other hand, in the case of a policy whereby “the first PPDU need not always be transmitted”, the value of the IFS may be set at a different value, such as a Distributed Coordination Function IFS (DIFS).

In a case where it has been judged that the TXOP responder permits transmission through the Preemption operation, the AP 101 according to the present embodiment sets a waiting time so that a waiting time before transmission of one of frames to be communicated with the STA 102 in the TXOP period becomes long. That is to say, the AP 101 makes a waiting time before transmission of one of the frames longer in a case where the Preemption operation is permitted than in a case where the Preemption operation is not permitted. For example, in a case where the STA 102 does not permit transmission through the Preemption operation, all inter-frame intervals are set at the SIFS; on the other hand, in a case where the STA 102 permits transmission through the Preemption operation, at least one of the inter-frame intervals is set at the DIFS. In this way, the STAs 103 and 104 that have requested the Preemption operation can detect an idle state of a medium, and execute transmission through the Preemption operation. Note that in a case where transmission through the Preemption operation is permitted, it is sufficient that the inter-frame intervals be larger than the SIFS, and they are not limited to the DIFS.

Also, in the present embodiment, the AP 101 sets the waiting time before transmission of a frame addressed to the TXOP responder by adjusting the IFS. However, a method of adjusting the waiting time before frame transmission is not limited to this, and the waiting time before frame transmission may be adjusted by adjusting the number of slots of the contention window.

Furthermore, setting of the waiting time so as to extend the waiting time before transmission of one of the data frames addressed to the STA 102 in the TXOP period includes an act by the AP 101 of refraining from transmitting one of the data frames addressed to the STA 102 in the TXOP period. For example, it is assumed that, in a case where the Preemption operation is not permitted, a second data frame is transmitted after a waiting time of the SIFS following a first data frame. Here, in a case where the Preemption operation is permitted, the waiting time until transmission of the second data frame may be set to be the length of two SIFSs and the first data frame by refraining from transmitting the first data frame. This can also cause the occurrence of transmission through the Preemption operation.

Step S908 is processing during an IFS period. In step S908, the control unit 202 monitors whether the time decided in step S907 elapses with a medium remaining in an idle state. In a case where the IFS period has elapsed with the medium remaining idle, the control unit 202 causes processing to proceed to step S909. On the other hand, in a case where the IFS time has not elapsed with the medium remaining in the idle state, such as a case where PPDUs from the STA 103 that has requested the Preemption operation have been received before the elapse of the IFS, predetermined processing, like transmission of a BA after the end of transmission by the STA103, is executed.

In step S909, the control unit 202 transmits the downlink data frames received in step S901 to the destination STA, which is the TXOP responder in the present example. In step S910, the control unit 202 receives a BA for the data frames received in step S909 from the TXOP responder.

In step S911, the control unit 202 confirms the remaining time of TXOP, that is to say, the remaining time of the period in which the Preemption operation is permitted. This is based on the time designated by the pRTS frame transmitted in step S904, and on the time designated by the pCTS frame received in step S905.

In a case where the TXOP period remains (YES of step S911), the control unit 202 causes processing to proceed to step S912. In a case where it has been judged that the TXOP period is not left (NO of step S911), the control unit 202 ends the downlink processing shown in FIG. 9A and FIG. 9B.

In step S912, the control unit 202 confirms whether the TXOP responder permits the Preemption operation in the current state. This confirmation is made by the AP 101 judging whether the TXOP responder permits the Preemption operation based on the received pCTS frame or CTS frame. In a case where the control unit 202 has judged that the Preemption operation is permitted (YES of step S912), the control unit 202 causes processing to proceed to step S913. In a case where the control unit 202 has judged that the Preemption operation is rejected (NO of step S912), the control unit 202 causes processing to proceed to step S915.

In step S913, the control unit 202 confirms whether the BA frame received in step S910 indicates that the Preemption operation is permitted. In a case where the control unit 202 has judged that the BA frame indicates that the Preemption operation is permitted (YES of step S913), the control unit 202 causes processing to return to step S907. On the other hand, in a case where the control unit 202 has judged that the received BA frame indicates that the Preemption operation is rejected (NO of step S913), the control unit 202 causes processing to proceed to step S914.

In step S914, the control unit 202 sets the normal PPDU length as the length of PPDUs, and causes processing to proceed to step S919. That is to say, in a case where the BA frame indicates that the Preemption operation is not permitted, the waiting time before transmission of frames addressed to the TXOP responder is set to be longer than the waiting time in a case where the Preemption operation is permitted in steps S914 and S919.

In step S915, the control unit 202 confirms whether the BA frame received in step S910 indicates that the Preemption operation is permitted. In a case where the control unit 202 has judged that the BA indicates that the Preemption operation is permitted (YES of step S915), the control unit 202 causes processing to proceed to step S916. On the other hand, in a case where the control unit 202 has judged that the BA indicates that the Preemption operation is rejected (NO of step S915), the control unit 202 causes processing to proceed to step S919.

In step S916, the control unit 202 sets the length of PPDUs to be shorter than the normal PPDU length, and causes processing to proceed to step S907. Processing of step S916 is similar to processing of step S906.

In step S918, the control unit 202 judges whether a CTS frame has been received. In a case where CTS has been received, the control unit 202 causes processing to proceed to step S919. In step S919, the IFS is set as the SIFS, and processing proceeds to step S908.

Note that the present embodiment is described under the assumption that the Preemption operation is permitted in a case where the pCTS frame has been received, and the Preemption operation is rejected in a case where the CTS frame has been received. However, in a case where whether to permit or reject the Preemption operation is indicated by information in the pCTS frame, different processing may be executed in steps S905 and S918. For example, after step S904, processing may proceed to step S906 in a case where the information in the pCTS frame permits the Preemption operation, and processing may proceed to step S919 in a case where the information does not permit the Preemption operation.

In other words, it is sufficient that step S906 be executed as processing for a case where the received pCTS permits the Preemption operation, and step S919 be executed as processing for a case where the received pCTS rejects the Preemption operation. Similarly, processing of FIG. 9A and FIG. 9B can be executed with replacements also in a case where information inside the CTS frame indicates whether the Preemption operation is permitted, or in a case where information in another frame indicates whether the Preemption operation is permitted, as stated earlier.

In a case where CTS has not been received in step S918 (NO of step S918), the control unit 202 causes processing to proceed to step S920. Processing of step S920 is executed in a case where the TXOP responder has failed to receive the pRTS frame, or the TXOP holder has failed to receive the pCTS frame or the CTS frame. Therefore, the control unit 202 decides the necessity of retransmission of the pRTS frame in step S920. In a case where the pRTS frame is to be retransmitted (YES of step S920), processing returns to step S904; otherwise, the downlink processing is considered to have failed, and processing shown in FIG. 9A and FIG. 9B ends (step S921). One example of a case where the pRTS frame is not retransmitted is a case where a limit value of the number of retransmissions of the pRTS frame has been reached.

### Exemplary Processing of TXOP Responder

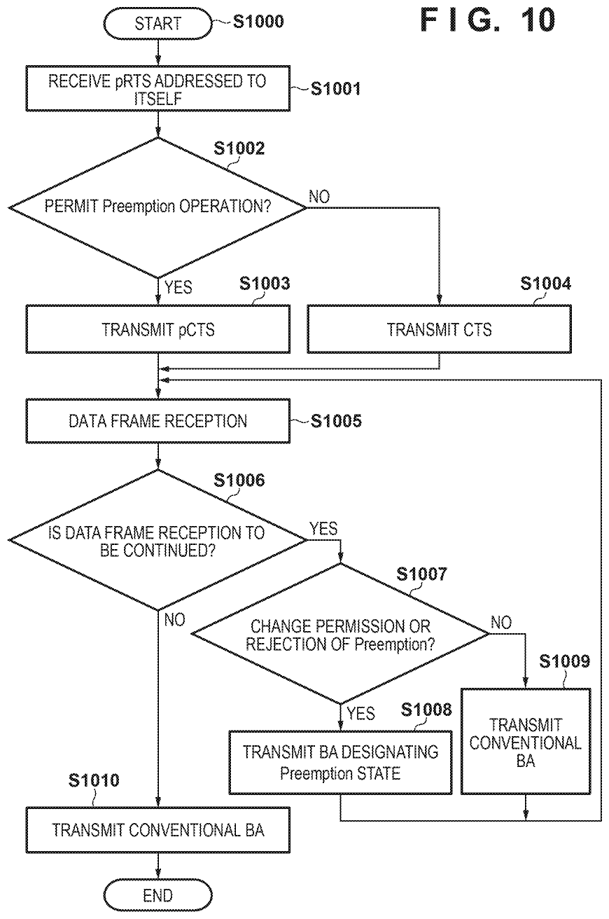

FIG. 10 is a flowchart showing exemplary processing of a wireless communication apparatus that receives a pRTS frame (TXOP responder). Processing shown in FIG. 10 is realized by the control unit 202 of the STA 102, which operates as the TXOP responder, executing a program at the start of a TXOP period (step S1000).

In step S1001, the control unit 202 receives a pRTS frame addressed to the STA 102. In step S1001, based on the received pRTS signal, it is possible to recognize that a request to permit transmission through the Preemption operation by an STA different from the STA 102 and the AP 101 has been made in the TXOP period assigned to the STA 102. In step S1002, the control unit 202 decides whether to permit or reject transmission through the Preemption operation by the STA different from the STA 102 and the AP 101.

In a case where the transmission by the STA different from the STA 102 and the AP 101 is permitted in the TXOP period (YES of step S1002), the control unit 202 causes processing to proceed to step S1003, and transmits a pCTS signal indicating that the transmission through the Preemption operation is permitted. Although the destination of a pCTS frame is the AP 101, other terminals that have detected the pCTS signal can recognize that the transmission through the Preemption operation is permitted, and the Preemption operation is made possible.

On the other hand, in a case where the transmission through the Preemption operation is not permitted (NO of step S1002), the control unit 202 causes processing to proceed to step S1004, and transmits a CTS frame indicating that the transmission through the Preemption operation is not permitted, that is to say, rejected. Although the destination of the CTS frame is the AP 101, other STAs that have detected the CTS frame can recognize that the transmission through the Preemption operation is rejected. In an example, the CTS frame can be transmitted when data should be received seamlessly before the reception of PPDUs, that is to say, when the STA 102 has recognized that there is a time limit (timeout) in data reception. For example, the STA 102 can recognize that there is a time limit in data reception based on an application executed by the STA 102.

In step S1005, the control unit 202 of the STA 102 receives PPDUs (data frames) from the AP 101. In step S1006, the control unit 202 judges whether there is a subsequent PPDU. In a case where the control unit 202 has judged that the reception of data frames has ended, that is to say, the reception of data frames is not to be continued (NO of step S1006), processing proceeds to step S1010; otherwise, processing proceeds to step S1007. In step S1010, the STA 102 transmits, to the AP 101, a BA conforming to the conventional standards, that is to say, a BA that does not indicate whether the transmission through the Preemption operation is permitted, and ends the downlink reception of FIG. 10.

In step S1007, the control unit 202 decides whether to change the state of permission or rejection of the transmission through the Preemption operation. That is to say, in step S1007, whether the permission or rejection of the Preemption operation is to be changed after the decision of step S1002 is determined. In a case where it has been judged that the state of permission or rejection of the transmission through the Preemption operation is to be changed (YES of step S1007), the control unit 202 causes processing to proceed to step S1008; otherwise, it causes processing to proceed to step S1009.

In step S1008, a BA indicating that the transmission through the Preemption operation is permitted or rejected is transmitted. In an example, after making the decision to permit the transmission through the Preemption operation in step S1002, the transmission through the Preemption operation can be rejected in a case where an application that performs low-latency communication has been executed. In another example, after making the decision to reject the transmission through the Preemption operation in step S1002, a BA frame indicating that the transmission through the Preemption operation is permitted can be transmitted in step S1008 as a result of receiving at least one PPDU and analyzing data. Also, even in a case where the pCTS frame has been transmitted in step S1003, the STA 102 can analyze data after receiving one or more PPDUs, and judge that downlink data should be received seamlessly. In this case, the STA 102 can transmit a BA frame that rejects transmission through the Preemption operation. This has the meaning of cancelling the permission for transmission of the Preemption operation by the pCTS frame transmitted in step S1003. Also, after the BA frame has been transmitted in step S1008, a BA designating a state different from the previous time can be transmitted after it has been decided that the state of permission or rejection of Preemption is to be changed as a result of executing processing of step S1007 again. Note that in the TXOP period, this BA frame indicating permission or rejection of the transmission through the Preemption operation can be transmitted without any limit.

In step S1009, the control unit 202 transmits a BA frame that does not include information about permission or rejection of the Preemption operation (a conventional BA frame). After processing of step S1008 or S1009, the control unit 202 causes processing to return to step S1005.

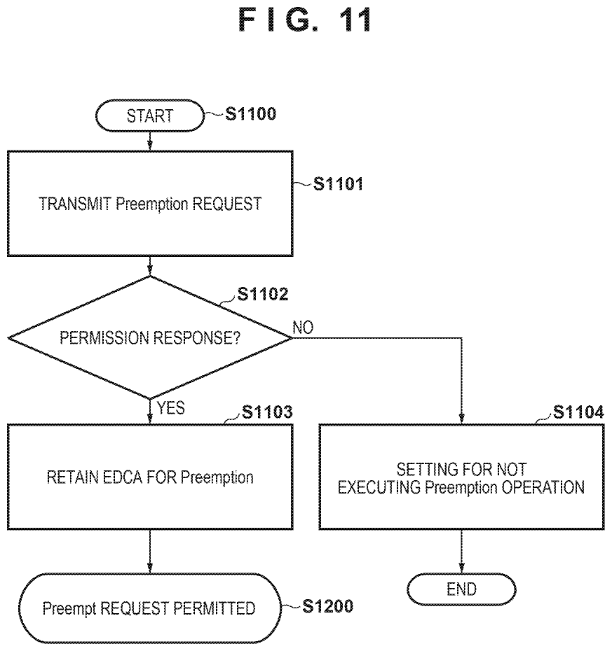

FIG. 11 is a flowchart showing exemplary processing executed by STAs that request transmission through the Preemption operation. The present exemplary processing will be described under the assumption that the STAs 103 and 104 request transmission through the Preemption operation. Processing shown in FIG. 11 is realized by the control units 202 of the STAs 103 and 104 executing a program. In an example, processing shown in FIG. 11 is executed on the occurrence of a traffic with latency requirements, like in a case where the STAs 103 and 104 have executed an application that performs low-latency communication, in a normal state after connecting to the AP 101.

In step S1101, the control unit 202 transmits a Preemption request to the AP 101, and receives a Preemption response. Subsequently, in step S1102, the control unit 202 judges whether the Preemption response received from the AP 101 permits transmission through the Preemption operation. In a case where it has been judged that the Preemption response received from the AP 101 permits transmission through the Preemption operation (YES of step S1102), the control unit 202 causes processing to proceed to step S1103; otherwise, it causes processing to proceed to step S1104.

In step S1103, EDCA parameters included in the Preemption response (priority EDCA parameters) are stored in distinction from normal EDCA parameters, and processing proceeds to step S1200. As stated earlier, the priority EDCA parameters can include an AIFSN for deciding a contention window. In step S1104, it is judged that the transmission through the Preemption operation is not permitted, channel access parameters are set so that transmission is not performed in a TXOP period in which the STAs 103 and 104 are not TXOP responders, and processing ends. In an example, after processing of step S1104, the control unit 202 may wait for a predetermined time and execute processing shown in FIG. 11 again.

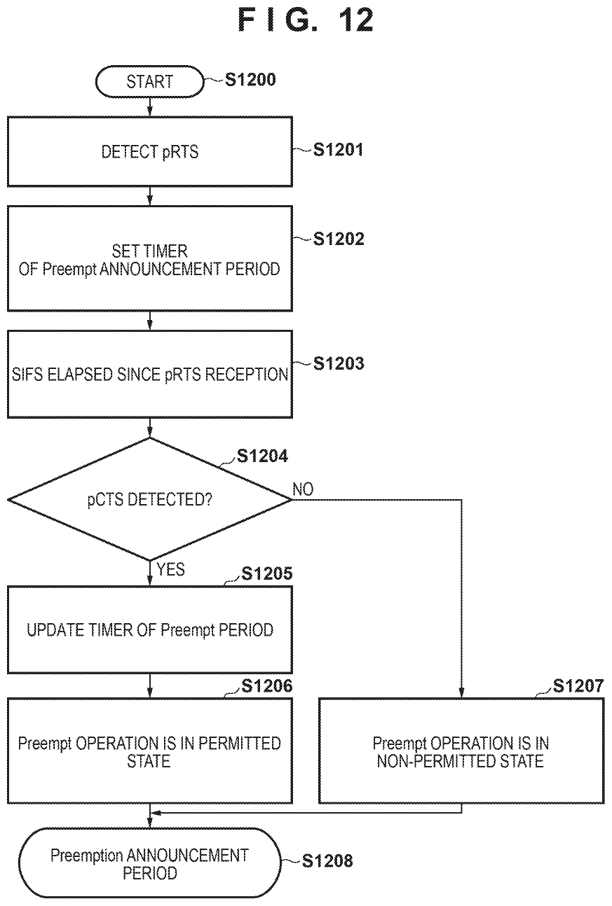

FIG. 12 is a flowchart showing the details of processing of step S1200. Step S1200 is realized by the control unit 202 of the STA 103 or 104 executing a program following processing of step S1103 of FIG. 11. The following description will be provided under the assumption that the control unit 202 of the STA 103 executes processing of FIG. 12. Note that processing of FIG. 12 is executed before a Preemption announcement period.

In step S1201, the control unit 202 receives a pRTS frame from the AP 101. In step S1202, based on the received pRTS frame, the control unit 202 sets a timer for a period in which the Preemption operation is performed. The time of this timer is Duration included in the pRTS frame.

Here, there is a possibility that the TXOP responder permits the Preemption operation during the period prescribed by Duration. Therefore, in a case where the control unit 202 functions as a state control unit that controls the state of the STA 103, the STA 103 requesting the Preemption operation maintains a normal state (a first state) and does not make a transition to a power save mode (a second state) in the TXOP period. In an example, the first state is a state where a MAC frame transmitted from another STA, such as a BA frame, is decoded and analyzed. The second state is a state where a MAC frame transmitted from another STA, such as a BA frame, is not decoded, or information of a decoded MAC frame, such as a BA frame, is not analyzed.

In step S1203, the control unit 202 waits until the SIFS time elapses since the reception of the pRTS frame. Next, in step S1204, the control unit 202 judges whether a pCTS frame has been detected. In a case where the pCTS frame has been detected (YES of step S1204), the control unit 202 causes processing to proceed to step S1205; otherwise, it causes processing to proceed to step S1207.

In step S1205, the control unit 202 updates the timer for the period in which the Preemption operation is performed with use of a value of Duration in the pCTS frame.

In step S1206, the control unit 202 judges that the state of the STA 103 is the state where the Preemption operation is permitted. In this state, an access is made using priority EDCA parameters included in the Preemption response, rather than normal EDCA parameters included in a beacon signal transmitted from the AP 101 or default EDCA parameters. Here, the default EDCA parameters are parameters that are used when accessing a medium outside the Preemption announcement period.

Processing of step S1207 is processing for a case where the STA 103 has detected a CTS frame, or has detected nothing, after an SIFS that is an inter-frame interval after the pRTS frame; the control unit 202 judges that the Preemption operation is not permitted in the current state. In this case, the control unit 202 performs a conventional operation, that is to say, does not perform a medium access that uses the priority EDCA parameters included in the Preemption response in the Preemption announcement period.

After processing of step S1206 or S1207, the control unit 202 of the STA 103 causes processing to proceed to processing in the Preemption announcement period in step S1208.

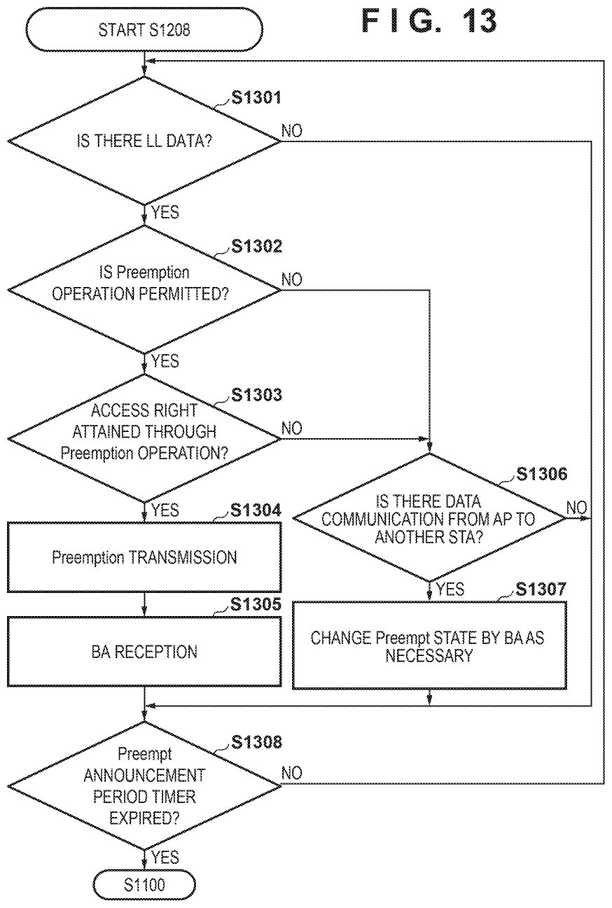

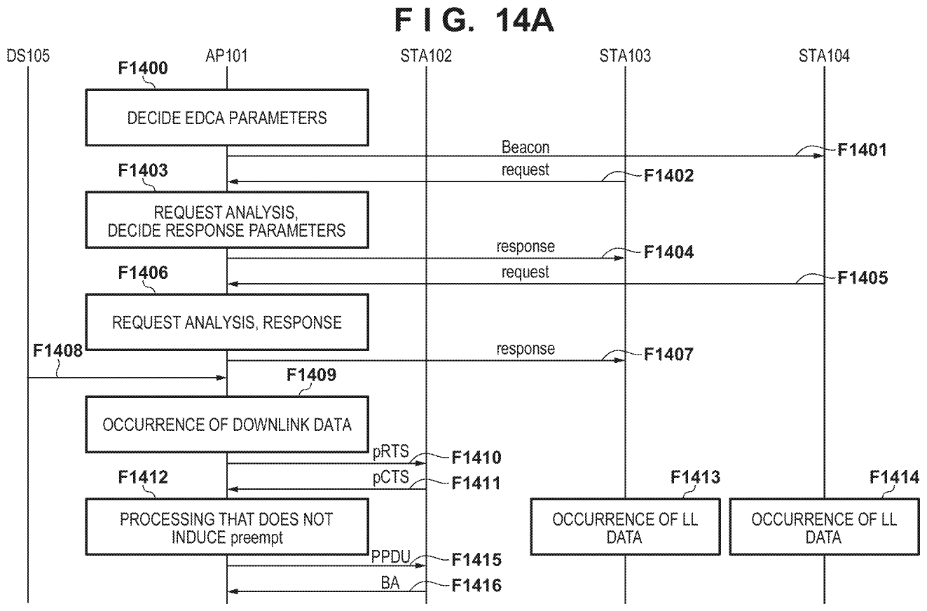

FIG. 13 is a flowchart showing exemplary processing executed by the control units 202 of the STAs 103 and 104 that have requested transmission through the Preemption operation in the Preemption announcement period. The present example will be described under the assumption that the STA 103 executes processing of FIG. 13. It is assumed that processing shown in FIG. 13 is executed by starting the Preemption announcement period timer following step S1206 or S1207 of FIG. 12.

In step S1301, the control unit 202 judges whether uplink data of LL communication is retained in a buffer. In a case where the control unit 202 has judged that the uplink data of the LL communication is retained (YES of step S1301), it causes processing to proceed to step S1302, and judges whether the Preemption operation is in the permitted state. In a case where the control unit 202 has judged that the uplink data of the LL communication is not retained (NO of step S1301), it causes processing to proceed to step S1308 without performing data transmission.

In a case where the control unit 202 has judged that the Preemption operation is permitted (YES of step S1302), it causes processing to proceed to step S1303, and judges whether an access right for Preemption transmission has been attained. In a case where the control unit 202 has judged that the Preemption operation is not permitted (NO of step S1302), it causes processing to proceed to step S1306.

In step S1303, the control unit 202 performs carrier sensing between contention windows that have been determined from the priority EDCA parameters included in the Preemption response, and judges that the access right has been attained in a case where it has judged that a medium is in an idle state. In a case where the access right has been attained (YES of step S1303), the control unit 202 causes processing to proceed to step S1304, and transmits LL data to the AP 101. UHR PPDUs can be used as wireless frames in this transmission. In a case where the control unit 202 has judged that the access right has not been attained (NO of step S1303), it causes processing to proceed to step S1306.

After performing the transmission through the Preemption operation in step S1304, the control unit 202 causes processing to proceed to step S1305, receives a BA frame from the AP 101, and causes processing to proceed to step S1308. In step S1308, the control unit 202 judges whether the Preemption announcement period timer has expired by comparing the value of Duration included in the received pRTS frame with the elapsed time indicated by the timer. In a case where the Preemption announcement period timer has expired (YES of step S1308), the control unit 202 causes processing to return to step S1100 and makes a transition to a normal state; in a case where the timer has not expired (NO of step S1308), it causes processing to return to step S1301.

In step S1306, the control unit 202 judges whether downlink communication from the AP 101 to the STA 102 (TXOP responder) has occurred. In a case where the control unit 202 has judged that downlink communication has occurred (YES of step S1306), it causes processing to proceed to step S1307.

In step S1307, the control unit 202 updates the state of permission for the Preemption operation in accordance with the content of a BA frame from the STA 102 (TXOP responder). That is to say, even in a case where the Preemption operation has been rejected by the CTS frame, the STA 103 judges that the Preemption operation is in a permitted state when executing processing of step S1302 again in a case where the BA frame received in step S1307 indicates that the Preemption operation is permitted. In this way, the STA that executes the Preemption operation can detect that the state of permission or rejection of the Preemption operation by the STA 102, which is the TXOP responder, has changed in the Preemption announcement period. Here, the reason why the BA frame transmitted from the TXOP responder can be detected is because the pCTS frame is in a detected state in step S1204. In a case where the access right through the Preemption operation has not been attained in a state where downlink communication has not occurred, the control unit 202 causes processing to proceed to step S1308.

Hereinafter, some embodiment examples will be described with reference to operational sequences of the DS 105, AP 101, and STAs 102 to 104.

### First Embodiment Example

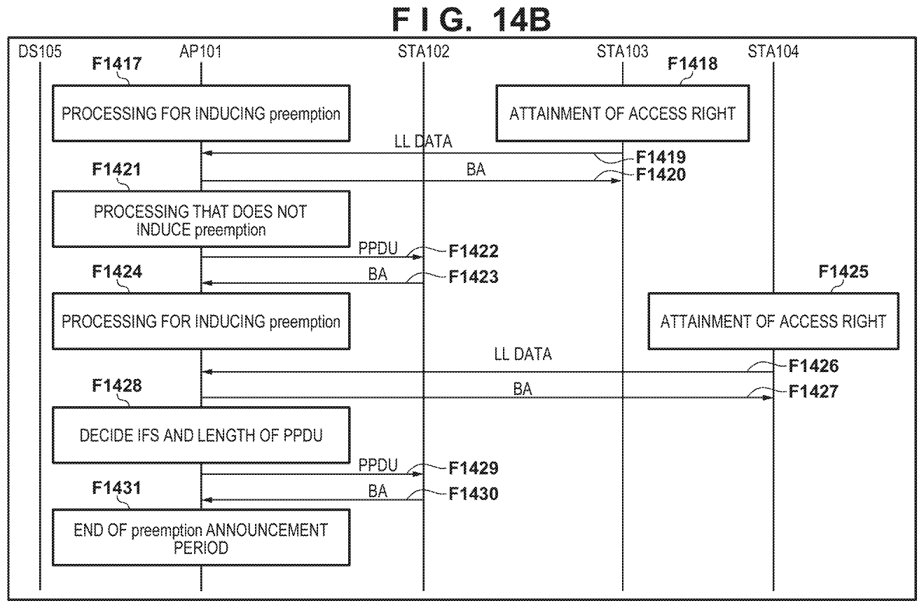

FIG. 14A and FIG. 14B show an operational sequence of a first embodiment example according to the present embodiment. In the following description, reference signs in FIG. 8 to FIG. 13 are indicated in parentheses in correspondence with reference signs in FIG. 14A and FIG. 14B.

In F1400 (step S801), the AP 101 decides EDCA parameters in a normal state. In F1401 (step S804), the AP 101 transmits a beacon signal. In the example of FIG. 14A and FIG. 14B, it is assumed that the STAs 102 to 104 receive the beacon signal.

In F1402 (step S1101), the STA 103 transmits a Preemption request to the AP 101. This enables the AP 101 to detect that the STA 103 is requesting a permission for transmission through the Preemption operation.

In F1403 (step S805), the AP 101 analyzes a Preemption response, and decides EDCA parameters for the Preemption operation (priority EDCA parameters) in accordance with a policy. In this case, these EDCA parameters are superior to the EDCA parameters notified by the beacon in a case where the policy allows the Preemption operation. These superior parameters mean parameters that are expected to, when deciding a contention window, enable a medium access in less time than when the decision is made in accordance with inferior parameters. The parameters that enable a medium access in less time denote at least one of: parameters including smaller CWmin; parameters including smaller CWmax; and parameters including smaller (CWmax−CWmin)/2.

In F1404 (step S809), the AP 101 returns a Preemption response to the STA 103. Consequently, the STA 103 can acquire the EDCA parameters for accessing a medium in a case where the Preemption operation is performed.

In F1405 (step S1101), the STA 104 transmits a Preemption request to the AP 101. In F1406 (steps S806 to S808), the AP 101 analyzes a Preemption response, and decides priority EDCA parameters in accordance with a policy. In this case, in a case where the policy performs priority control on the first-come-first-served basis when the number of STAs requesting the Preemption operation is equal to or larger than two, the AP may provide a notification indicating parameters that are prior to the EDCA parameters notified by the beacon and are inferior to the EDCA parameters of which the STA 103 has been notified. This can reduce the possibility of collision of transmissions through the Preemption operation performed by a plurality of STAs in a Preemption announcement period. In F1407 (step S809), the AP 101 returns a Preemption response to the STA 104. Note, in the present embodiment example, it is assumed that neither the STA 103 nor the STA 104 is in a hidden terminal state relative to each other.

In F1408, the DS 105 transmits data for the STA 102 to the AP 101.

In F1409 (step S901), the AP 101 detects the occurrence of downlink data addressed to the STA 102.

In F1410 (step S904), the AP 101 transmits a pRTS frame to the STA 102. In F1411 (step S1003), the STA 102 transmits a pCTS frame to the AP 101 as a response to the pRTS frame received in F1410. Here, the STA 103 and the STA 104 may be or may not be capable of recognizing this pCTS frame.

In F1412 (steps S906 and S907), the AP 101 executes processing that does not induce the STA 103 and the STA 104 to perform transmission through the Preemption operation. As this processing that does not induce Preempt, the AP 101 sets an SIFS as a value of an IFS. The processing of F1412 is executed when, for example, the first PPDU is transmitted to the STA 102. At this time, as the STA 102 recognizes the attribute (transmission source) and content of data in subsequent PPDUs from the content of the PPDU, it can judge whether to cause the permitted state of the Preemption operation to continue based on the PPDU.

Data of LL communication occurs in the STA 103 in F1413 (step S1301), and data of LL communication occurs in the STA 104 in F1414 (step S1301). That is to say, the STAs 103 and 104 judge that the transmission through the Preemption operation is necessary in F1413 and F1414. It is assumed that the nature of these pieces of data of LL communication is such that the timing of occurrence thereof cannot be predicted (cannot be scheduled). In this sequence, it is assumed that the pieces of data of LL communication occur before the start of the IFS, which is an inter-frame interval, after the transmission from the AP 101 to the STA 102.

In F1415 (step S909), the AP 101 transmits PPDUs after the SIFS has elapsed after the pCTS frame. At this time, the STA 103 and the STA 104 cannot attain an access right because the IFS of the STA 103 and the STA 104 is larger than the SIFS, that is to say, the AIFSN thereof is not 0.

In F1416 (step S910), the STA 102 transmits a BA frame to the AP 101. It is assumed that this BA frame is a conventional BA frame, that is to say, does not include information that can determine whether the Preemption operation is permitted. The AP 101 judges that the STA 102, from which it has received the BA frame transmitted in F1416, is in a state where the Preemption operation is permitted therefor.

In F1417 (steps S907 and S908), the AP 101 executes processing for inducing transmission through the Preemption operation. The processing for inducing transmission through the Preemption operation is to refrain from transmission of PPDUs even when the SIFS has elapsed since the reception of the BA frame. This control to refrain from transmission is performed until the elapse of time that is equivalent to the AIFSN for Preemption of which the STA 103 has been notified by the AP 101. In this way, the AP 101 can provide the opportunity of transmission by an STA requesting the Preemption operation in a Preemption announcement period.

In F1418 (step S1303), the STA 103 attains an access right. Here, it is assumed that the STA 103 sets CWmin and CWmax at 0 (zero), and does not decrement the backoff counter in the Preemption operation.

In F1419 (step S1304), the STA 103 transmits PPDUs including data of LL communication to the AP 101. In F1420 (step S1305), the AP 101 transmits a BA frame for the PPDUs transmitted in F1419 to the STA 103.

Note that in this sequence, it is assumed that the AIFSN of the STA 104 is larger than the AIFSN of the STA 103, and the STA 104 and the STA 103 are not hidden terminals relative to each other. This prevents collision caused by transmission performed by the STA 104 during transmission performed by the STA 103.

Processing from F1421 to F1424 is similar to F1412 and F1415 to F1417. Note, it is assumed that LL data is not retained in the STA 103, and LL data of F1414 is retained in the STA 104. It is also assumed that, in F1424, a medium is in an idle state until the elapse of time equivalent to the AIFSN for Preemption of which the STA 104 has been notified by the AP 101.

In F1425 (step S1303), the STA 104 attains an access right. In F1426 (step S1304), the STA 104 transmits PPDUs including LL data. In F1427 (step S1305), the AP 101 transmits a BA frame to the STA 104. As F1428 to F1430 are similar to F1412, F1415, and F1416, a description thereof is omitted.

In F1431, the Preemption announcement period designated by Duration of pRTS ends, and processing of FIG. 14A and FIG. 14B ends.

As described above, in the present embodiment, collision attributed to the Preemption operation can be avoided by differentiating (giving priority/inferiority to) AIFSNs of EDCA parameters of which a plurality of terminals are notified when permitting the Preemption operation. In this way, flexible priority control can be performed, and convenience in the Preemption operation can be improved.

### Second Embodiment Example

A second embodiment example will now be described with reference to FIG. 14A and FIG. 14B. Note that as processing before F1422 is similar to that of the first embodiment example, a description thereof is omitted.

In the second embodiment example, the STA 102 transmits a BA frame including information indicating that the Preemption operation is not permitted to the AP 101 in F1423. In this case, processing of F1425 to F1427 does not occur, and processing proceeds to F1431.

In this way, after a TXOP responder has permitted the Preemption operation via a pCTS frame, the permission for the Preemption operation can be cancelled during a Preemption announcement period designated by Duration included in the pCTS frame. In this way, a change in a status of the TXOP responder can be flexibly addressed, and convenience in the Preemption operation can be improved.

### Third Embodiment Example

A third embodiment example will now be described with reference to FIG. 14A and FIG. 14B. Note that as processing before F1410 is similar to that of the first embodiment example, a description thereof is omitted.

In F1411, the STA 102 transmits a CTS frame, rather than a pCTS frame, to the AP 101. In this case, processing of F1418 to F1420 or F1425 to F1427 does not occur, and processing proceeds to F1431.

In this way, a TXOP responder can reject the Preemption operation with use of the CTS frame, and the Preemption operation can be executed while reflecting the intention of the TXOP responder. In this way, convenience in the Preemption operation can be improved.

### Fourth Embodiment Example

In the first embodiment example, the AP 101 provides a notification of an end of a Preemption announcement period at any timing that is at or after F1412. This can be done by the following two methods.

In the first method, the AP 101 transmits a Preemption response indicating that the Preemption operation is not permitted to an STA in F1404 or F1407. This is indicated by Status Code or EDCA parameters. This is not a direct response to a Preemption request, but is a response by an unsolicited response action frame.

In the second method, the AP 101 transmits CF-End (an RA is a broadcast address) as a notification indicating an end of a Preemption announcement period in a TXOP period. This notification indicating the end of the Preempt announcement period can be provided freely by the AP 101, or provided upon request from a TXOP holder. Here, this request can be realized by a reserved field (7 bits) in a BA frame.

By using such an end frame, a change in a status of the TXOP holder in a Preemption period designated by Duration included in a pRTS frame can be flexibly addressed, and convenience in the Preemption operation can be improved.

### Fifth Embodiment Example

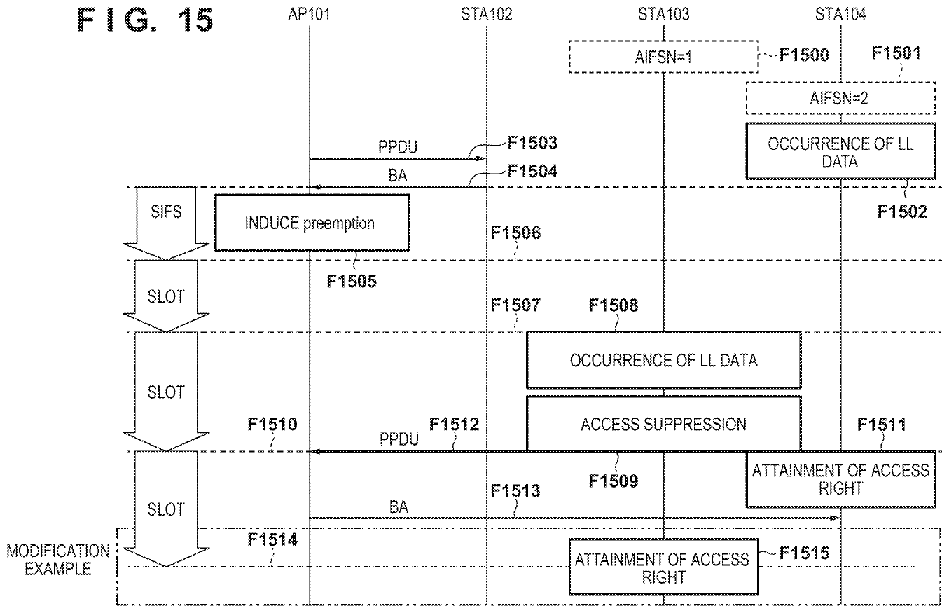

With reference to FIG. 15, a description is now given of processing for a case where the timing at which the AP 101 induces the Preemption operation and the timing of occurrence of LL data in an STA are close to each other.

It is assumed that the STA 103 is set to operate under AIFSN=1 in F1500, and the STA 104 is set to operate under AIFSN=2 in F1501. That is to say, it is assumed that the STA 103 has access parameters that are superior to those of the STA 104.

In F1502, data of LL communication occurs in the STA 104. In F1503, the AP 101 transmits PPDUs to the STA 102. Note that, at this time, the AP 101 performs access control so that the STA 103 and the STA 104 do not perform the Preemption operation. In F1504, the STA 102 transmits a BA frame to the AP 101.

In F1505, the AP 101 starts processing for inducing transmission related to the Preemption operation. In this case, the AP 101 refrains from transmission from the AP 101 during two slots (corresponding to two aSlotTimes) after an SIFS so that the STA 104 becomes a target.

The SIFS elapses in F1506, and one slot after the SIFS elapses in F1507.

Here, it is assumed that LL data occurs in the STA 103 in F1508. In the present embodiment example, the STA 103 does not perform transmission through the Preemption operation even in a case where data of LL communication does not exist when the AIFSN has elapsed and data of LL communication has occurred before the elapse of the next slot time. Therefore, in F1509, the STA 103 refrains from a medium access.

Two slots after the SIFS elapse in F1510. As a result, the STA 104 attains an access right in F1511, and the STA 104 transmits PPDUs (LL data) in F1512. In F1513, the AP 101 transmits a BA frame to the STA 104.

In this way, as a result of the STA 103 refraining from a medium access in F1509, collision with F1512, in which another STA performs transmission, is prevented. It is assumed here that the transmission timing of each STA, including the AP 101, is decided on a per-slot basis, and transmission is not started in the middle of a slot.

Note that dash-dot-dot lines in FIG. 15 indicate a case where F1511 to F1513 have not been executed as a modification of the present embodiment example. In F1514, the STA 103 attains an access right (F1515) after the elapse of a normal AIFSN slot time that is not related to the Preemption operation. In this way, the STA 103 can transmit LL data to the AP 101.

In this way, limiting a timing of a medium access in the Preemption operation to the AIFSN slot basis brings about the advantageous effect of reducing the possibility of collision, improving the efficiency of use of a wireless medium, and improving convenience in the Preemption operation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication apparatus compatible with an IEEE 802.11 series standard, the communication apparatus comprising:
at least one memory that stores a set of instructions; and
at least one processor that executes the instructions, the instructions, when executed, causing the communication apparatus to perform operations comprising:
communicating with a first other communication apparatus in a transmission opportunity (TXOP) period that is obtained by the communication apparatus and is for transmitting one or more data frames to the first other communication apparatus;
receiving, from the first other communication apparatus, information for determining whether the first other communication apparatus allows a second other communication apparatus different from the first other communication apparatus to transmit one or more data frames to the communication apparatus in the TXOP period; and
in a case of a determination, based on the received information, that the first other communication apparatus allows the second other communication apparatus to transmit the one or more data frames in the TXOP period, setting a waiting time before the communication apparatus transmits at least one data frame addressed to the first other communication apparatus in the TXOP period to be longer than the waiting time for a case of a determination that the first other communication apparatus does not allow the second other communication apparatus to transmit the one or more data frames in the TXOP period.

2. The communication apparatus according to claim 1, wherein
the communicating includes transmitting a permission request to the first other communication apparatus, the permission request requesting allowance of transmission of the one or more data frames by the second other communication apparatus in the TXOP period,
the receiving includes receiving a response to the permission request from the first other communication apparatus, and
the setting includes determining, based on the received response, whether the first other communication apparatus allows the second other communication apparatus to transmit the one or more data frames in the TXOP period.

3. The communication apparatus according to claim 2, wherein
the communicating includes transmitting an occupancy request frame that requests obtainment of the TXOP period as the permission request, and
the setting includes
in a case where a Clear To Send (CTS) frame is received as a response to the occupancy request frame, determining that the first other communication apparatus does not allow the second other communication apparatus to transmit the one or more data frames in the TXOP period, and
in a case where an occupancy response frame different from the CTS frame is received as a response to the occupancy request frame, determining that the first other communication apparatus allows the second other communication apparatus to transmit the one or more data frames in the TXOP period.

4. The communication apparatus according to claim 2, wherein
the communicating includes transmitting an occupancy request frame that requests obtainment of the TXOP period as the permission request,
the receiving includes receiving an occupancy response frame as a response to the occupancy request frame, and
the setting includes determining, in a case of a judgment that the received occupancy response frame includes predetermined information, that the first other communication apparatus allows the second other communication apparatus to transmit the one or more data frames in the TXOP period.

5. The communication apparatus according to claim 3, wherein
at least one of a Type field, a Subtype field, and a Control Frame Extension field of a Request To Send (RTS) frame, a Clear To Send (CTS) frame, or a Medium Access Control (MAC) frame differs between the occupancy request frame and the occupancy response frame.

6. The communication apparatus according to claim 2, wherein
the communicating includes transmitting a Request To Send (RTS) frame as the permission request,
the receiving includes receiving a Clear To Send (CTS) frame as the response, and
the setting includes determining, in a case of a judgment that the received CTS frame includes predetermined information, that the first other communication apparatus allows the second other communication apparatus to transmit the one or more data frames in the TXOP period.

7. The communication apparatus according to claim 1, wherein
the setting includes, in a case where a Block ACK (BA) frame is received as a response to the data frames transmitted to the first other communication apparatus in the TXOP period, judging whether the first other communication apparatus allows the second other communication apparatus to transmit the one or more data frames in the TXOP period based on the received BA frame.

8. The communication apparatus according to claim 1, wherein
the receiving includes
receiving a transmission request from the second other communication apparatus, the transmission request requesting allowance of transmission of the one or more data frames by the second other communication apparatus in the TXOP period, and
transmitting an Enhanced Distributed Channel Access (EDCA) parameter to the second other communication apparatus as a response to the transmission request, the EDCA parameter being used to access a medium in a case where the second other communication apparatus is allowed to transmit the one or more data frames in the TXOP period.

9. The communication apparatus according to claim 8, wherein
the EDCA parameter includes an Arbitration Inter Frame Space Number (AIFSN) with a value larger than 0.

10. The communication apparatus according to claim 1, wherein
the setting includes, in a case of a determination that the first other communication apparatus allows the second other communication apparatus to transmit the one or more data frames in the TXOP period, setting a maximum length of the data frames transmitted from the communication apparatus to the first other communication apparatus in the TXOP period to be shorter than the maximum length for a case of a determination that the first other communication apparatus does not allow the second other communication apparatus to transmit the one or more data frames in the TXOP period.

11. The communication apparatus according to claim 1, wherein
the setting includes, in a case of a determination that the first other communication apparatus allows the second other communication apparatus to transmit the one or more data frames in the TXOP period, controlling a frame length of the data frames so that a total number of inter-frame intervals of the data frames transmitted from the communication apparatus to the first other communication apparatus in the TXOP period is larger than a total number of inter-frame intervals of the data frames for a case of a determination that the first other communication apparatus does not allow the second other communication apparatus to transmit the one or more data frames in the TXOP period.

12. The communication apparatus according to claim 1, wherein
the setting includes
in a case of a determination that the first other communication apparatus does not allow the second other communication apparatus to transmit the one or more data frames in the TXOP period, setting all inter-frame intervals before frames transmitted from the communication apparatus to the first other communication apparatus to a Short Inter Frame Space (SIFS), and
in a case of a determination that the first other communication apparatus allows the second other communication apparatus to transmit the one or more data frames in the TXOP period, setting inter-frame intervals before the communication apparatus transmits one of frames addressed to the first other communication apparatus to be larger than the SIFS.

13. The communication apparatus according to claim 1, wherein
the setting includes, in a case of a determination that the first other communication apparatus does not allow the second other communication apparatus to transmit the one or more data frames in the TXOP period, setting inter-frame intervals to be larger in a waiting time before the communication apparatus transmits one of frames addressed to the first other communication apparatus in the TXOP period than in a waiting time before the first other communication apparatus accesses a medium in the TXOP period.

14. The communication apparatus according to claim 1, wherein
the receiving includes receiving information that enables determining whether other communication apparatuses connected to the communication apparatus are mutually detected by one another, and
the setting includes, in a case of a determination that the first other communication apparatus allows the second other communication apparatus to transmit the one or more data frames in the TXOP period, and furthermore a predetermined condition related to whether the other communication apparatuses connected to the communication apparatus are mutually detected by one another is satisfied, setting a waiting time before one of frames transmitted from the communication apparatus to the first other communication apparatus in the TXOP period to be longer than a waiting time for a case of a determination that the first other communication apparatus does not allow the second other communication apparatus to transmit the one or more data frames.

15. The communication apparatus according to claim 1, wherein
the setting includes further judging whether to allow the second other communication apparatus to transmit the one or more data frames in the TXOP period, and
the communicating includes, in a case of a judgment that the second other communication apparatus is not allowed to transmit the one or more data frames in the TXOP period, providing a notification indicating that the communication apparatus does not allow the second other communication apparatus to transmit the one or more data frames in the TXOP period.

16. A communication apparatus compatible with an IEEE 802.11 series standard, the communication apparatus comprising:
at least one memory that stores a set of instructions; and
at least one processor that executes the instructions, the instructions, when executed, causing the communication apparatus to perform operations comprising:
receiving a signal transmitted from a second other communication apparatus in a transmission opportunity (TXOP) period that is obtained to transmit a data frame from a first other communication apparatus to the second other communication apparatus, and
in a case where the received signal indicates that the second other communication apparatus permits transmission by the communication apparatus in the TXOP period, performing control so that a signal to be transmitted to the first other communication apparatus is transmitted in a period in which a frame is not transmitted to the second other communication apparatus in the TXOP period.

17. The communication apparatus according to claim 16, wherein
the operations further comprise judging, based on the received signal, whether the second other communication apparatus permits transmission by the communication apparatus in the TXOP period,
the receiving includes receiving a response transmitted from the second other communication apparatus as a response to an occupancy request frame transmitted from the first other communication apparatus, the occupancy request frame requesting permission for transmission in the TXOP period, and
the controlling includes, in a case where an occupancy response frame different from a Clear To Send (CTS) frame is received as a response to the occupancy request frame, judging that the occupancy response frame indicates that the second other communication apparatus permits transmission by the communication apparatus in the TXOP period.

18. The communication apparatus according to claim 16, wherein
the operations further comprise judging, based on the received signal, whether the second other communication apparatus permits transmission by the communication apparatus in the TXOP period,
the receiving includes receiving an occupancy response frame transmitted from the second other communication apparatus as a response to an occupancy request frame transmitted from the first other communication apparatus, the occupancy request frame requesting permission for transmission in the TXOP period, and
the controlling includes, in a case of a judgment that the received occupancy response frame includes predetermined information, judging that the occupancy response frame indicates that the second other communication apparatus permits transmission by the communication apparatus in the TXOP period.

19. The communication apparatus according to claim 16, wherein
the operations further comprise judging, based on the received signal, whether the second other communication apparatus permits transmission by the communication apparatus in the TXOP period,
the receiving includes receiving a Clear To Send (CTS) frame transmitted from the second other communication apparatus as a response to a Request To Send (RTS) frame transmitted from the first other communication apparatus, the RTS frame requesting permission for transmission in the TXOP period, and
the controlling includes, in a case where the received CTS frame includes predetermined information, judging that the CTS frame indicates that the second other communication apparatus permits transmission by the communication apparatus in the TXOP period.

20. The communication apparatus according to claim 16, wherein
the operations further comprise judging, based on the received signal, whether the second other communication apparatus permits transmission by the communication apparatus in the TXOP period,
the receiving includes receiving a Block ACK (BA) frame transmitted from the second other communication apparatus as a response to a data frame transmitted from the first other communication apparatus to the second other communication apparatus, and
the controlling includes judging whether the received BA frame indicates that the second other communication apparatus permits transmission by the communication apparatus in the TXOP period.

21. The communication apparatus according to claim 16, wherein
the controlling includes, in a case where the received signal indicates that the second other communication apparatus permits transmission by the communication apparatus in the TXOP period, refraining from transmission of a signal to the first other communication apparatus in the TXOP period in a case where there is no uplink data of low-latency communication with the first other communication apparatus when access to a medium was enabled.

22. The communication apparatus according to claim 16, wherein
the operations further comprise transmitting, to the first other communication apparatus, a transmission request requesting transmission in the TXOP period, and
the receiving includes receiving an Enhanced Distributed Channel Access (EDCA) parameter as a response to the transmission request, the EDCA parameter being used to access a medium in a case where transmission by the communication apparatus in the TXOP period is permitted.

23. The communication apparatus according to claim 22, wherein
the operations further comprise switching between an operation in a first state in which a Medium Access Control (MAC) frame transmitted from other communication apparatus is decoded, and an operation in a second state that is a power save mode in which a MAC frame transmitted from other communication apparatus is not decoded, and
in the switching, the communication apparatus is placed in the first state in the TXOP period in a case where the EDCA parameter is received as a response to the transmission request.

24. A communication apparatus compatible with an IEEE 802.11 series standard, the communication apparatus comprising:
at least one memory that stores a set of instructions; and
at least one processor that executes the instructions, the instructions, when executed, causing the communication apparatus to perform operations comprising:
communicating with a first other communication apparatus in a transmission opportunity (TXOP) period that is obtained to receive one or more data frames from the first other communication apparatus; and
judging whether to permit transmission by a second other communication apparatus in the TXOP period,
wherein the communicating includes transmitting, to other communication apparatuses including at least the first other communication apparatus, a signal that enables determining whether to permit transmission by the second other communication apparatus in the TXOP period.

25. The communication apparatus according to claim 24, wherein
the communicating includes notifying other communication apparatuses including at least the first other communication apparatus of a signal indicating whether transmission by the second other communication apparatus in the TXOP period is permitted via at least one of a Clear To Send (CTS) frame requesting obtainment of the TXOP period, an occupancy request frame that is different from the CTS frame and requests obtainment of the TXOP period, and a Block ACK (BA) frame for a data frame received from the first other communication apparatus in the TXOP period.

26. A control method executed by a communication apparatus compatible with an IEEE 802.11 series standard, the control method comprising:
communicating with a first other communication apparatus in a transmission opportunity (TXOP) period that is obtained by the communication apparatus to transmit one or more data frames to the first other communication apparatus;
receiving, from the first other communication apparatus, information for determining whether the first other communication apparatus allows a second other communication apparatus different from the first other communication apparatus to transmit one or more data frames to the communication apparatus in the TXOP period; and
in a case of a determination, based on the received information, that the first other communication apparatus allows the second other communication apparatus to transmit the one or more data frames in the TXOP period, setting a waiting time before the communication apparatus transmits at least one data frame addressed to the first other communication apparatus in the TXOP period to be longer than the waiting time for a case of a determination that the first other communication apparatus does not allow the second other communication apparatus to transmit the one or more data frames in the TXOP period.

27. A control method executed by a communication apparatus compatible with an IEEE 802.11 series standard, the control method comprising:
receiving a signal transmitted from a second other communication apparatus in a transmission opportunity (TXOP) period that is obtained to transmit a data frame from a first other communication apparatus to the second other communication apparatus, and
in a case where the received signal indicates that the second other communication apparatus permits transmission by the communication apparatus in the TXOP period, transmitting a signal to the first other communication apparatus in the TXOP period.

28. A control method executed by a communication apparatus compatible with an IEEE 802.11 series standard, the control method comprising:
communicating with a first other communication apparatus in a transmission opportunity (TXOP) period that is obtained to receive one or more data frames from the first other communication apparatus;
judging whether to permit transmission by a second other communication apparatus in the TXOP period; and
notifying other communication apparatuses including at least the first other communication apparatus of a signal indicating whether to permit transmission by the second other communication apparatus in the TXOP period.

29. A non-transitory computer readable storage medium that stores a program that causes, when the program is executed, a communication apparatus to perform a control method according to claim 26.

30. A non-transitory computer readable storage medium that stores a program that causes, when the program is executed, a communication apparatus to perform a control method according to claim 27.

31. A non-transitory computer readable storage medium that stores a program that causes, when the program is executed, a communication apparatus to perform a control method according to claim 28.
